(19) United States
(12) Patent Application Publication
(10) Pub. No.: US 2011/0007231 A1
(43) Pub. Date: Jan. 13, 2011

(54) LIGHTING DEVICE, DISPLAY DEVICE AND TELEVISION RECEIVER

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/920,158

(22) PCT Filed: Feb. 18, 2009
(86) PCT No.: PCT/JP2009/052779

§ 371 Date: Aug. 30, 2010

(30) Foreign Application Priority Data
Mar. 5, 2008 (JP) 2008-055196

(51) Int. Cl. H04N 3/12; F21V 11/00; F21S 4/00; G02F 1/13357; G02F 1/1335

(52) U.S. Cl. 348/798; 362/235; 362/225; 362/97.1; 349/62; 348/E03.012

(57) ABSTRACT

A lighting device 12 of the present invention includes a light source 17, a chassis 14 configured to house the light source 17 and having an opening 14b for light from the light source 17 to pass through, and an optical member 15a provided so as to face the light source 17 and cover the opening 14b. The chassis 14 has a surface facing the optical member 15a. The surface includes at least a first end portion 30A, a second end portion 30B, and a middle portion 30C located between the first end portion 30A and the second end portion 30B. One or two of the first end portion 30A, the second end portion 30B and the middle portion 30C are configured as light source installation areas LA in each of which the light source 17 is arranged, and the rest is configured as an empty area LN in which no light source 17 is arranged. The optical member 15a has a portion that overlaps the light source installation area LA at least a surface of which faces the light source 17 has a light reflectance higher than a light reflectance of at least a surface of a portion that overlaps the empty area LN facing the light source 17.

### TECHNICAL FIELD

The present invention relates to a lighting device, a display device and a television receiver.

### BACKGROUND ART

A liquid crystal panel included in a liquid crystal display device does not emit light, and thus a backlight device is required as a separate lighting device. The backlight device is arranged behind the liquid crystal panel (i.e., on a side opposite from a display surface side). It includes a chassis having an opening on a liquid crystal panel side, a plurality of fluorescent tubes accommodated in the chassis as lamps, and an optical member (diffuser plate and the like) provided at the opening of the chassis for efficiently directing light emitted from the fluorescent tubes to a liquid crystal panel.

In such a backlight device where the fluorescent tubes emit linear light, a plurality of fluorescent tubes are aligned with each other and the optical member converts linear light into planer light to unify illumination light. However, if the linear light is not sufficiently converted into the planer light, striped lamp images are generated along the alignment of the fluorescent tubes, and this deteriorates display quality of the liquid crystal display device.

To obtain uniform illumination light from the backlight device, it is desirable to increase the number of lamps and reduce a distance between the adjacent lamps or to increase a diffusion rate of a diffuser plate, for example. However, increase of the number of lamps increases a cost of the backlight device and also increases power consumption. Increase of the diffusion rate of the diffuser plate fails to improve luminance and causes the problem that the number of lamps is required to be increased. A backlight device disclosed in Patent Document 1 has been known as one that suppresses power consumption and ensures uniform luminance.

The backlight device described in Patent Document 1 includes a diffuser plate for irradiating diffused light on the back of a display panel and a plurality of cold cathode fluorescent lamps arranged in parallel to each other. A plurality of cold cathode fluorescent lamps are installed so that their arrangement spaces in the center part corresponding to the center part of the display screen of the display panel are made narrower than the peripheral part corresponding to the peripheral part of the display screen, and are also installed so that the spaces between a plurality of the cold cathode fluorescent lamps and the diffuser plate are wider in the center part than in the peripheral part. Thereby, luminance in the center part of the display screen can be enhanced and the number of lamps is reduced in the peripheral part of the display screen, and this suppresses increase of power consumption.

[Patent Document] Japanese Unexamined Patent Publication No. 2005-347062

(Problem to be Solved by the Invention)

In the configuration disclosed in Patent Document 1, the lamps are arranged over the entire display screen, and therefore there is a limit to reduce the number of lamps. That is, if the number of lamps arranged in the peripheral part of the display screen is excessively reduced, the lamp image may be generated. Therefore, a predetermined number of lamps is required to be installed in the peripheral part of the display screen and the lamps are also required to be installed in the parts adjacent to the peripheral part. Therefore, the configuration of Patent Document 1 does not sufficiently respond to the request of power saving of recent liquid crystal display devices, and further consideration has been needed.

### DISCLOSURE OF THE PRESENT INVENTION

The present invention was made in view of the foregoing circumstances. An object of the present invention is to provide a lighting device in which light emitted from a light source is effectively used to ensure uniform brightness and achieve a cost reduction and power saving. Another object of the present invention is to provide a display device including such a lighting device and a television receiver including such a display device.

(Means for Solving the Problem)

To solve the above problem, a lighting device of the present invention includes at least one light source, a chassis that houses the light source and has an opening for light from the light source to pass through and an optical member provided so as to face the light source and cover the opening. The chassis has a surface that faces the optical member, and the surface includes at least a first end portion, a second end portion and a middle portion. The second end portion is located at an end away from the first end portion. The middle portion is located between the first end portion and the second end portion. One or two of the first end portion, the second end portion and the middle portion are configured as light source installation areas in each of which the light source is arranged, and the rest is configured as an empty area in which no light source is arranged. The optical member has a portion that overlaps the light source installation area at least a surface of which faces has a light reflectance higher than alight reflectance of at least a surface of a portion that overlaps the empty area facing the light source.

According to such a configuration, one or two of the first end portion, the second end portion and the middle portion are configured as the light source installation areas in which the light source is arranged, and the rest is configured as the empty area in which no light source is arranged. Therefore, compared to a case in which the light sources are arranged evenly in the entire chassis, the number of light sources is reduced and a cost reduction and power saving of the lighting device can be achieved.

As described above, when the empty area where no light source is arranged is provided, no light is output from the empty area. Therefore, the illumination light output through the opening of the chassis is darker in an area corresponding to the empty area and this may cause uneven light distribution.

However, according to the present invention, the optical member that is provided so as to cover the opening of the chassis has the portion that overlaps the light source installation area at least a surface of which faces the light source has a relatively high light reflectance. Moreover, the light reflectance of at least the surface of the portion that overlaps the empty area facing the light source is relatively low. Accordingly, light that comes from the light source installation area first reaches the portion of the optical member having the relatively high light reflectance. Therefore, most of the light reflects off the portion, that is, does not pass through the portion), and the brightness of illumination light is suppressed with respect to the light emission amount from the light source. On the other hand, the reflected light is further reflected within the chassis and reaches the empty area. The light reflectance of the portion of the optical member that overlaps the empty area is relatively low and thus a larger amount of light passes therethrough. As a result, predetermined brightness of illumination light is achieved.

Thus, the light emitted from the light source arranged in the light source installation area is reflected within the chassis by the portion of the optical member having the relatively high light reflectance is directed to the empty area. The light reflectance of the optical member is relatively low in the empty area to output the illumination light from the empty area where no light source is installed. As a result, the light sources are not required to be arranged in the entire lighting device, and therefore a cost reduction and power saving can be achieved.

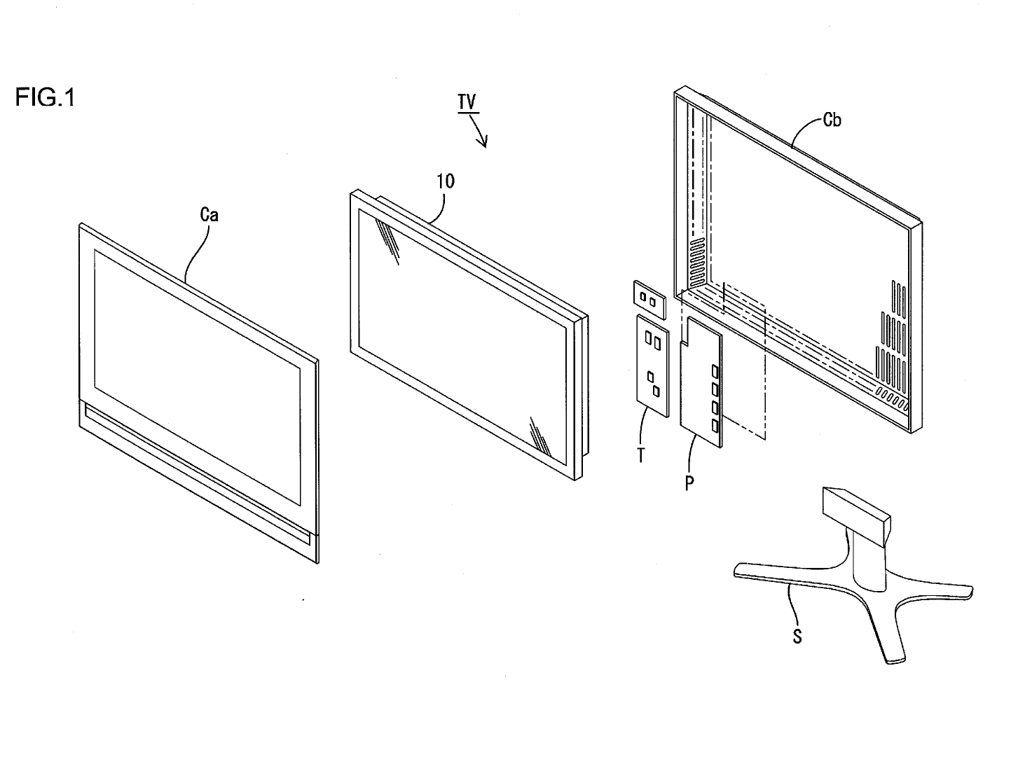

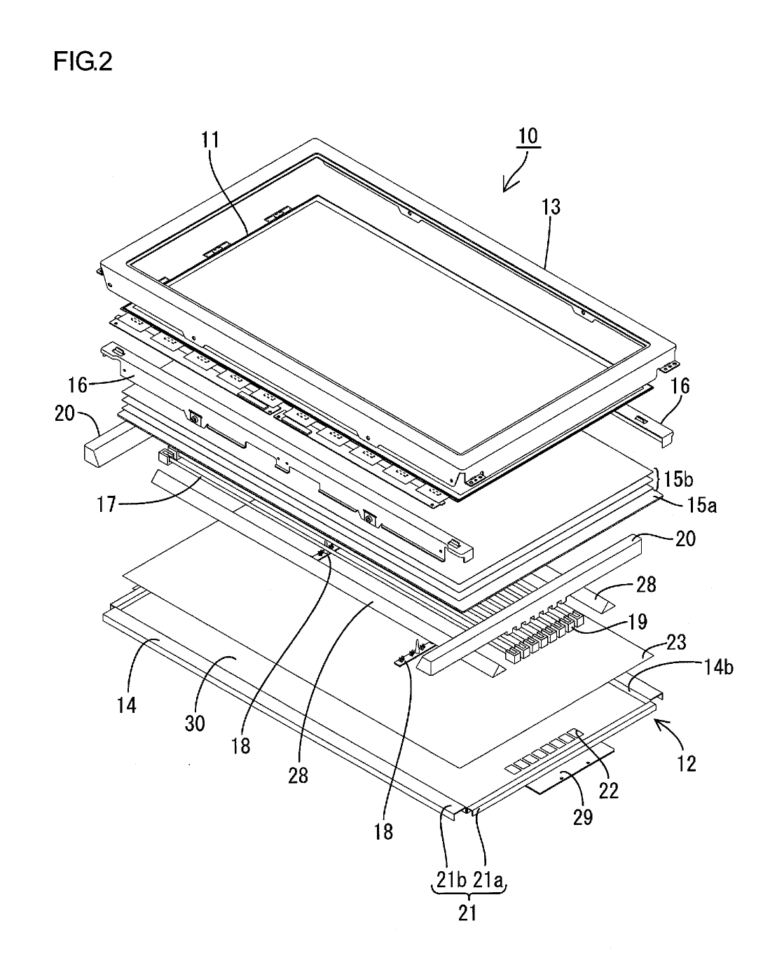

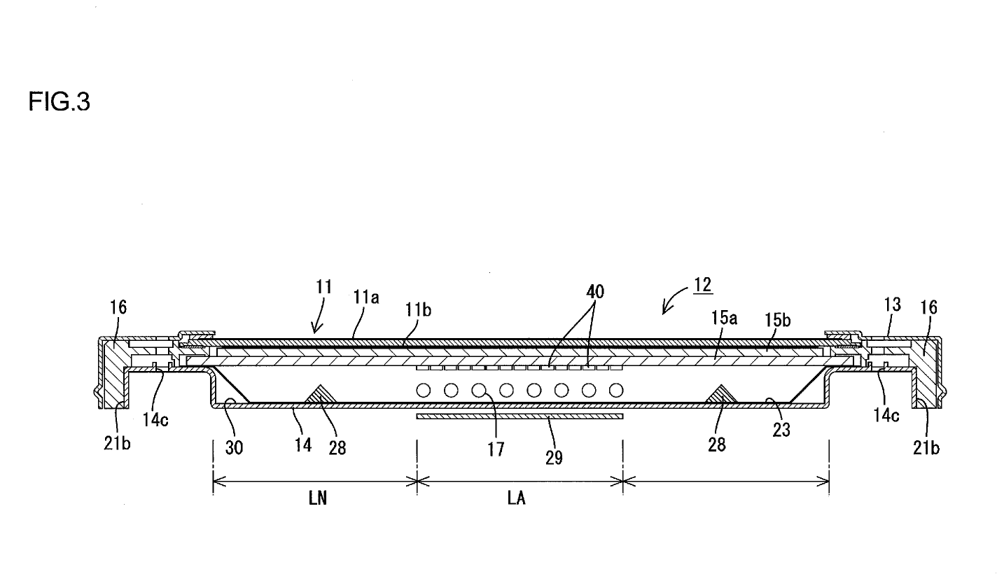

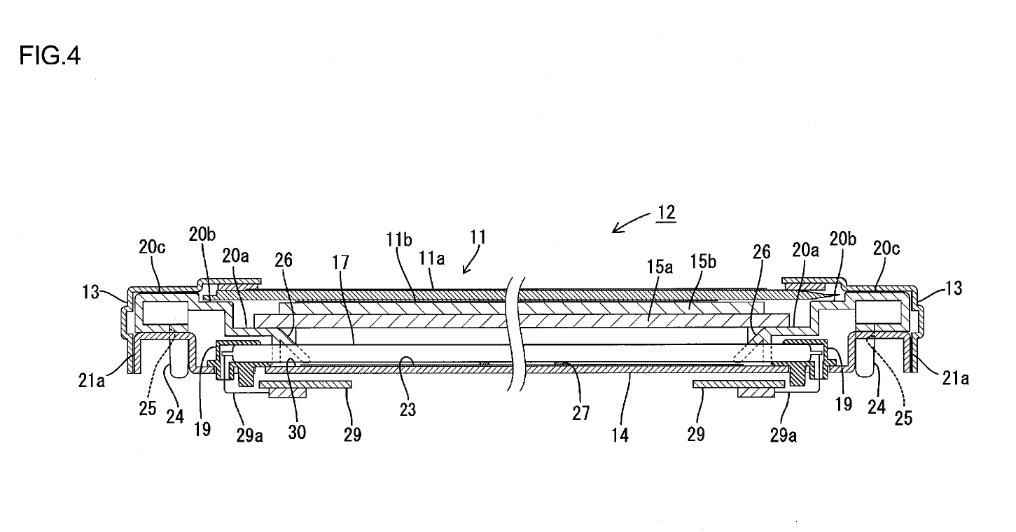

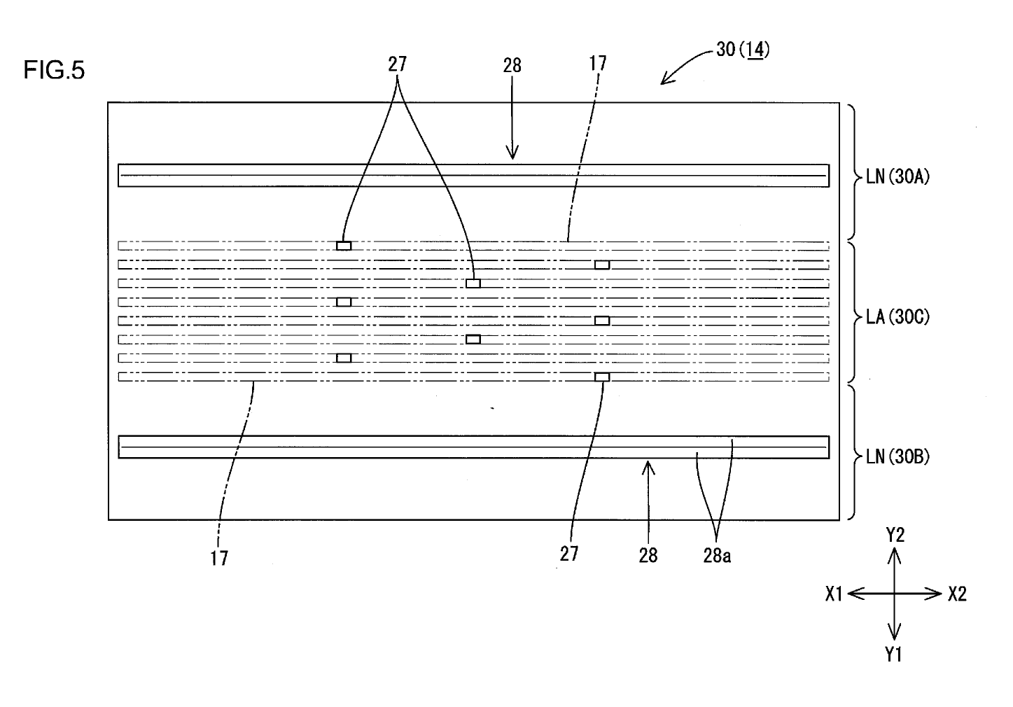

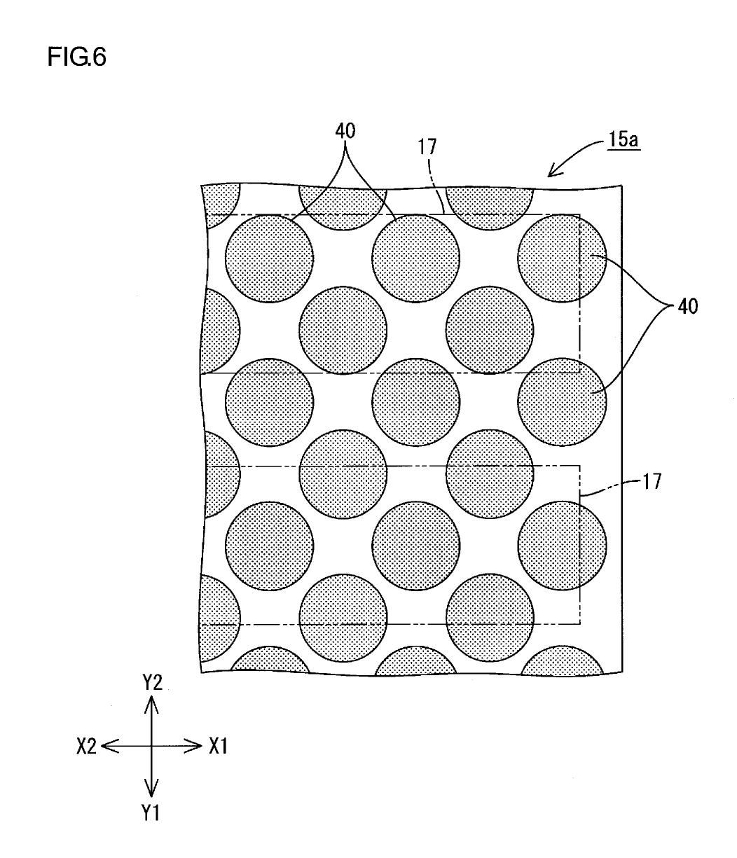

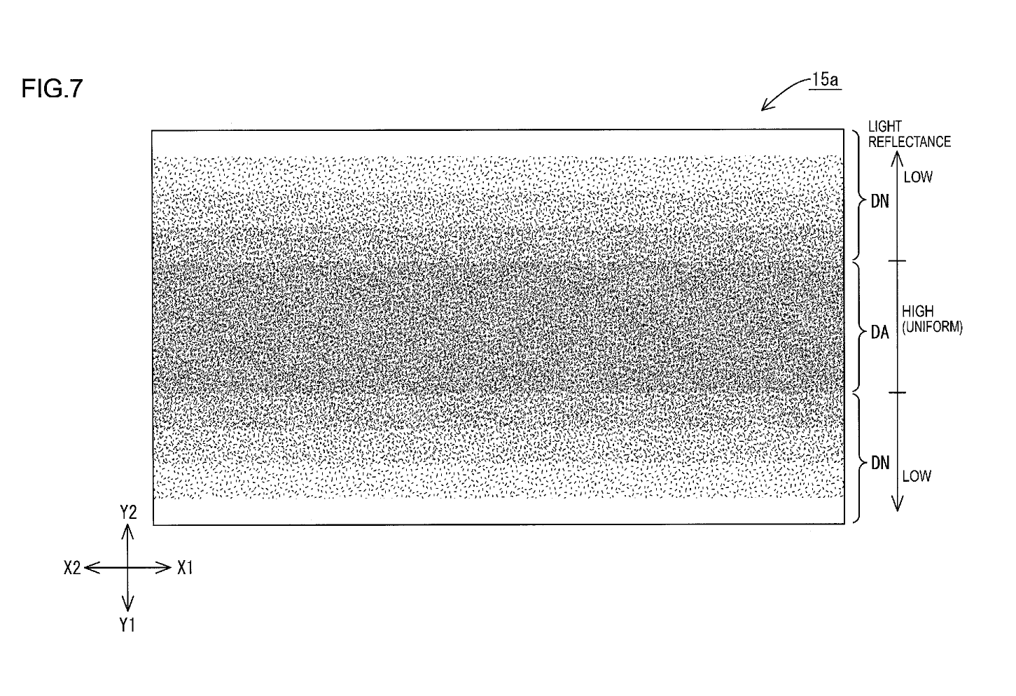

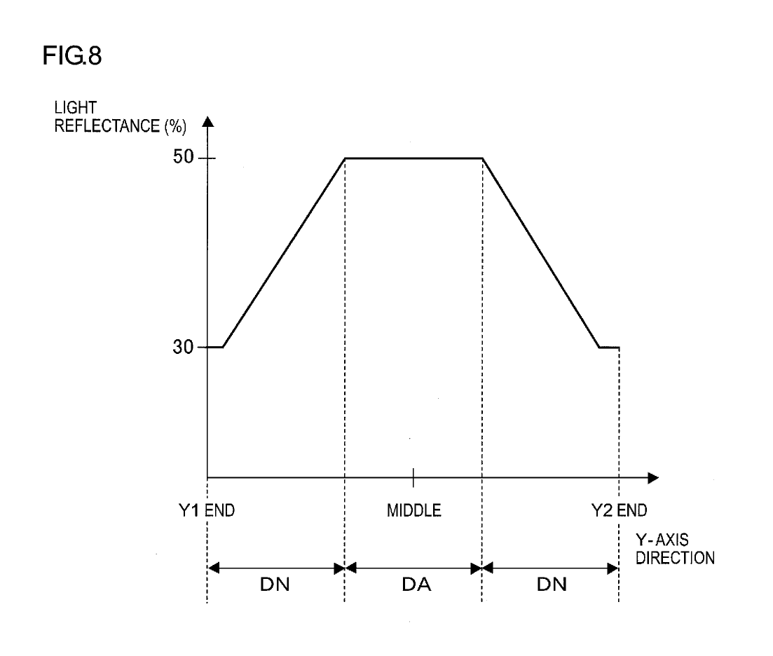

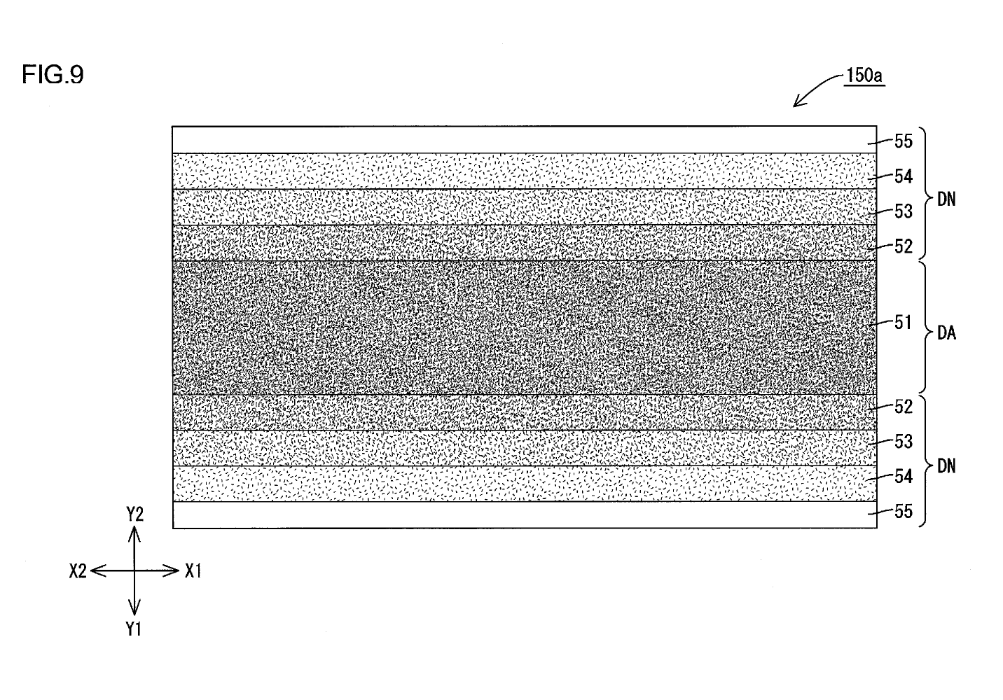

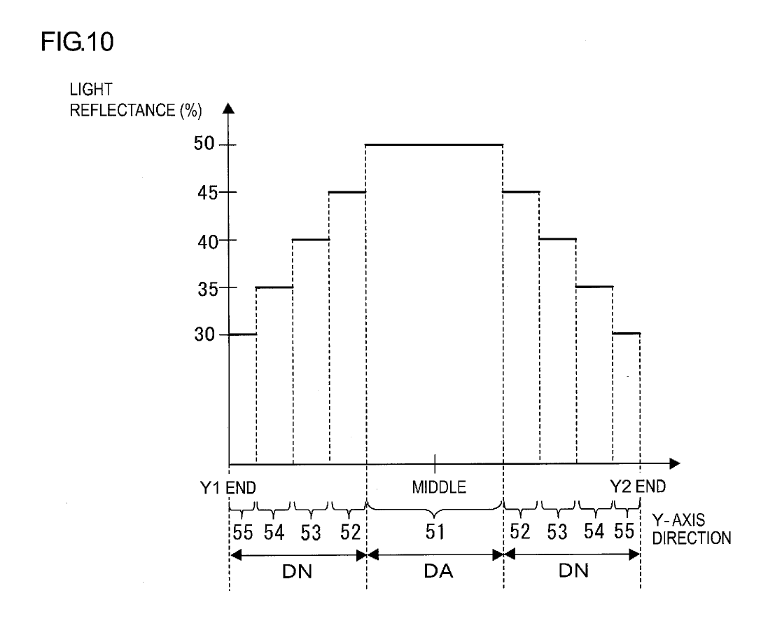

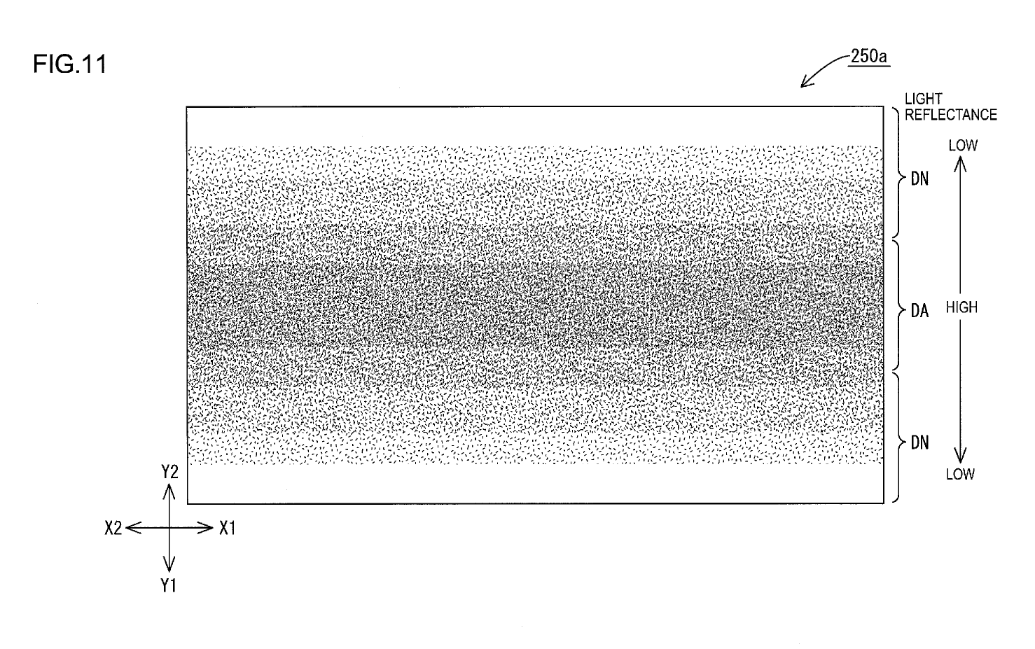

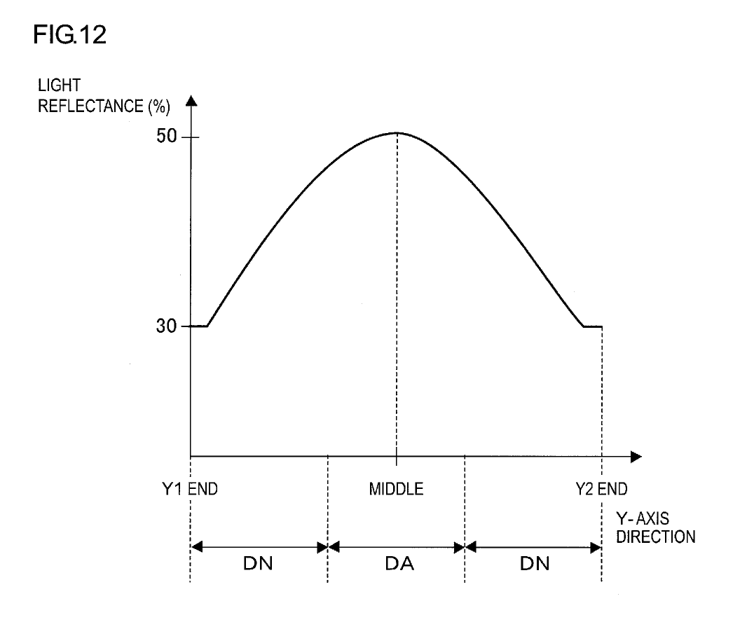

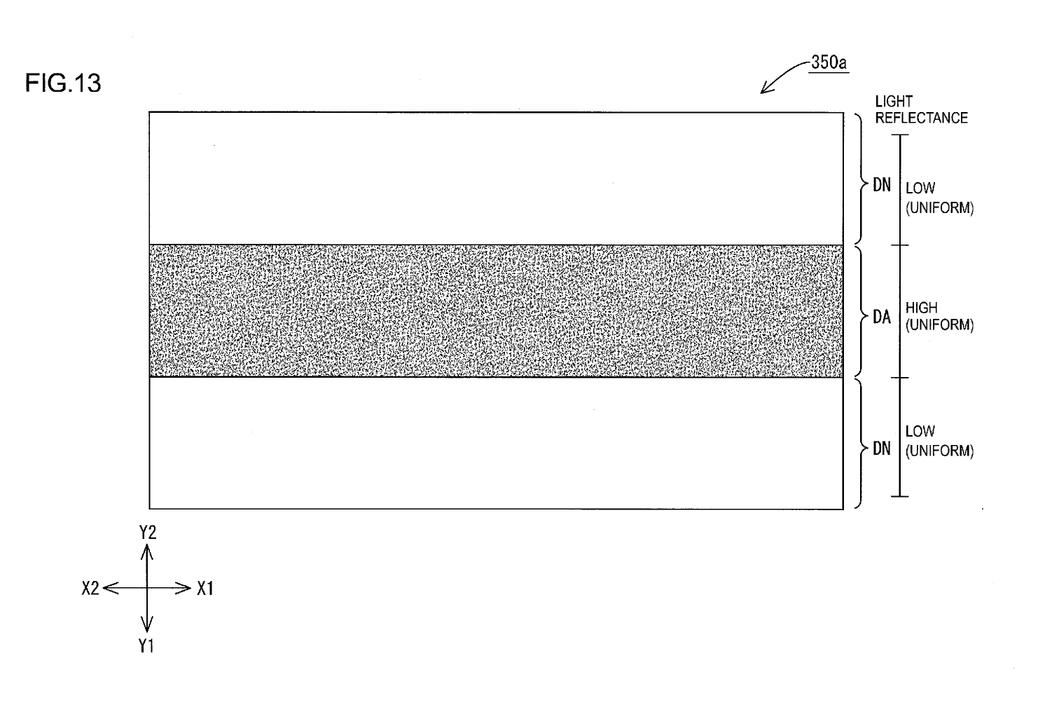

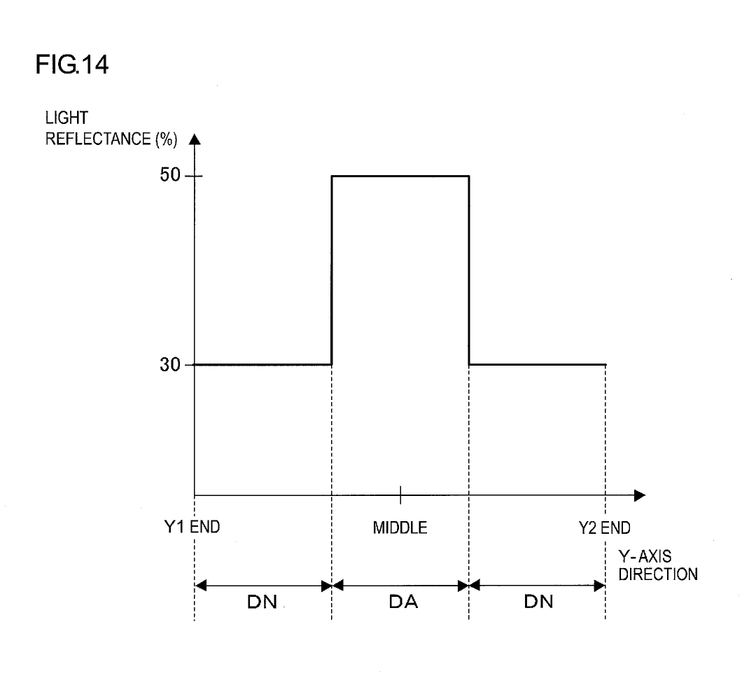

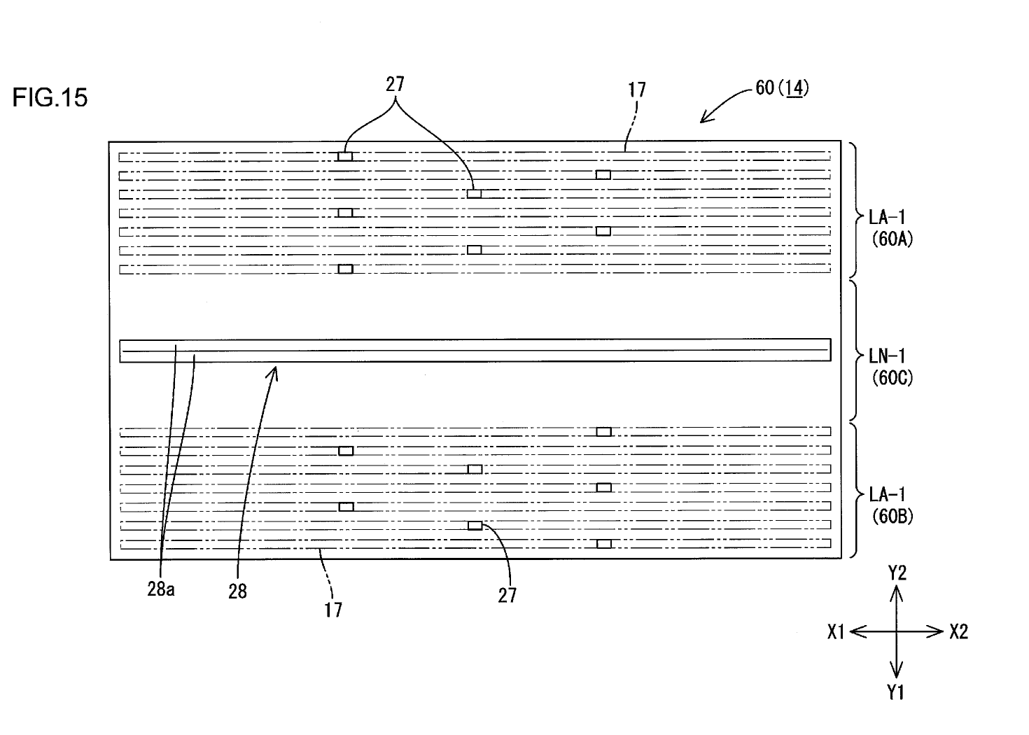

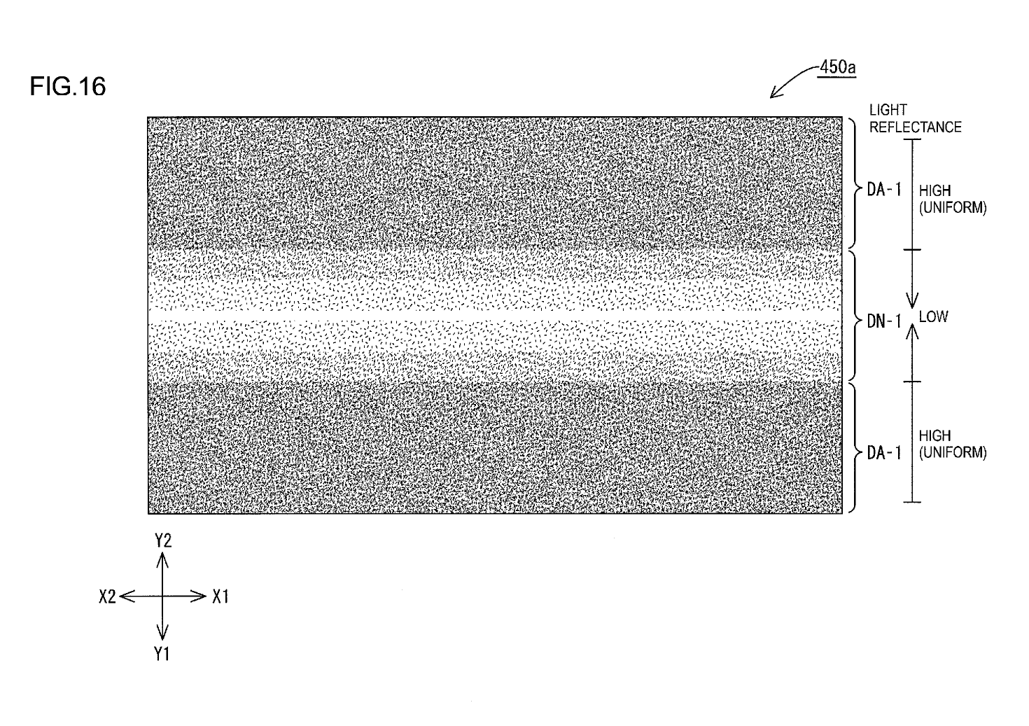

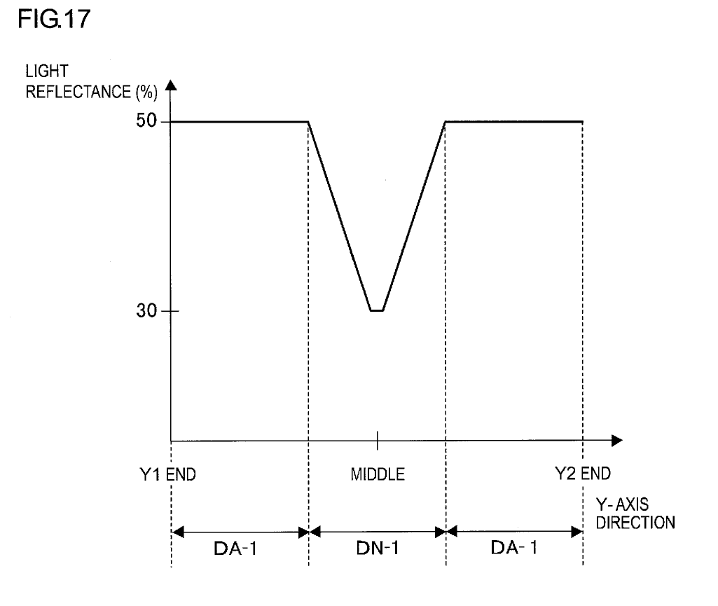

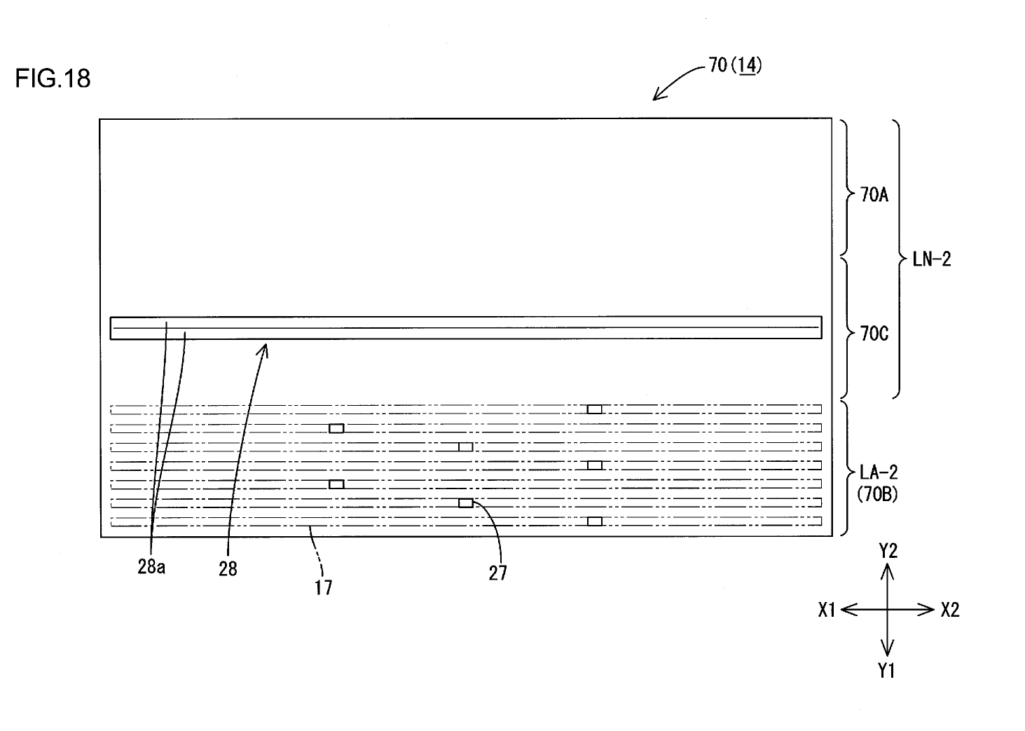

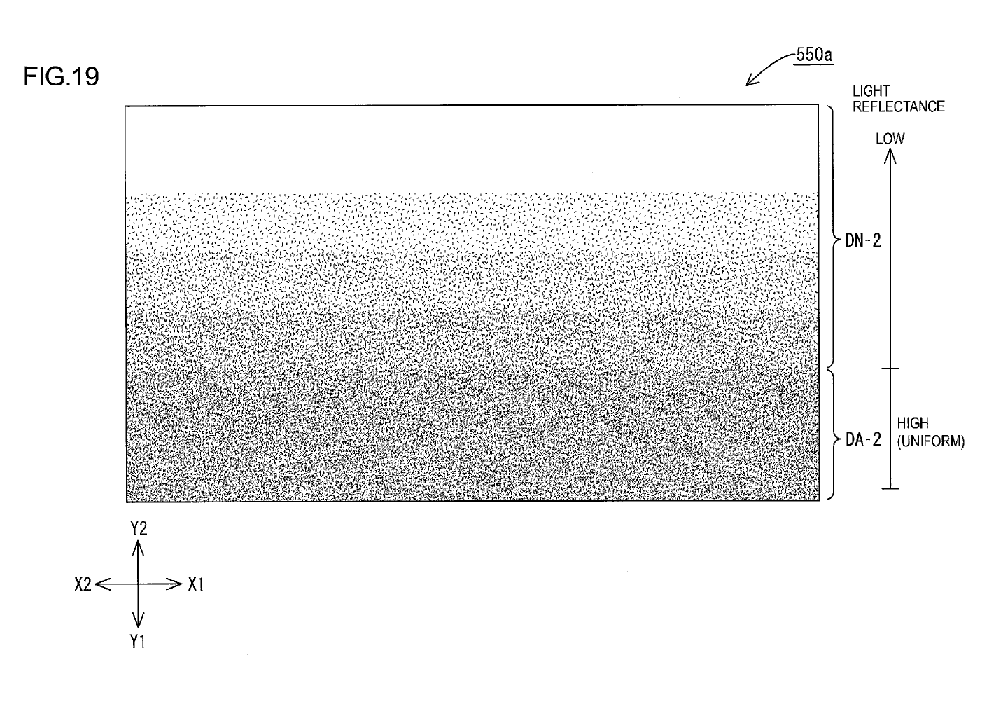

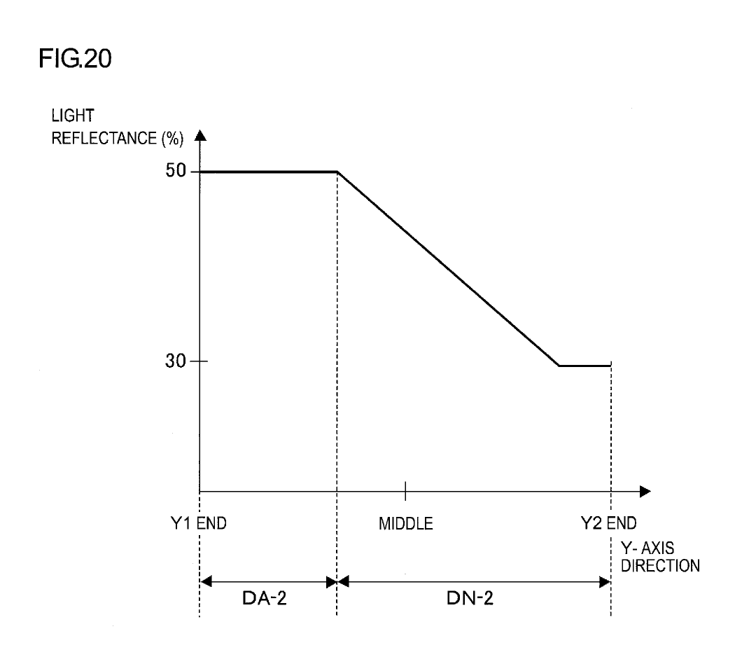

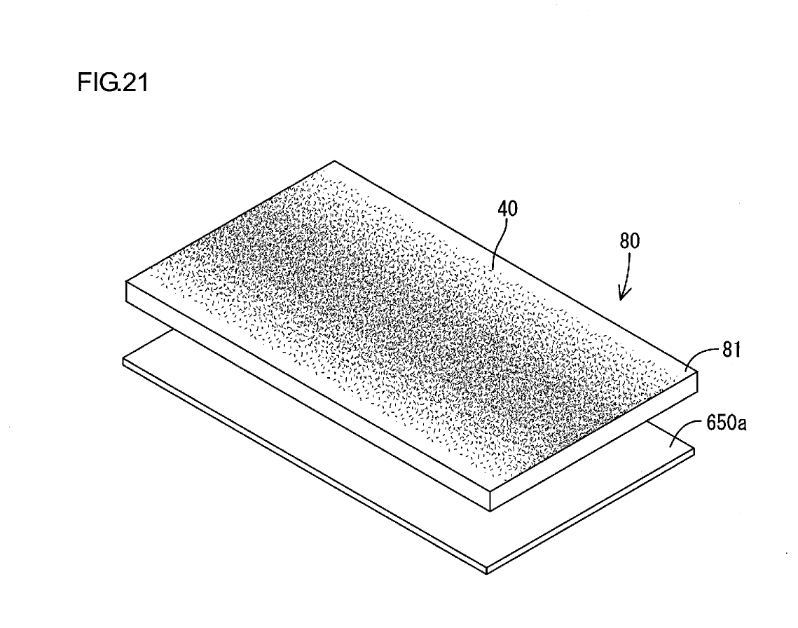

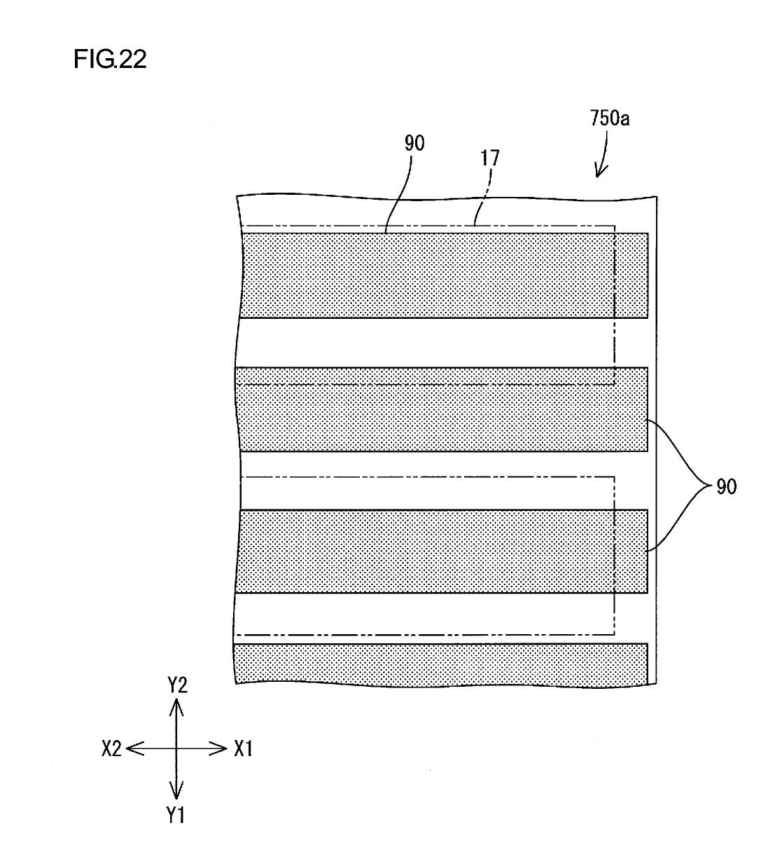

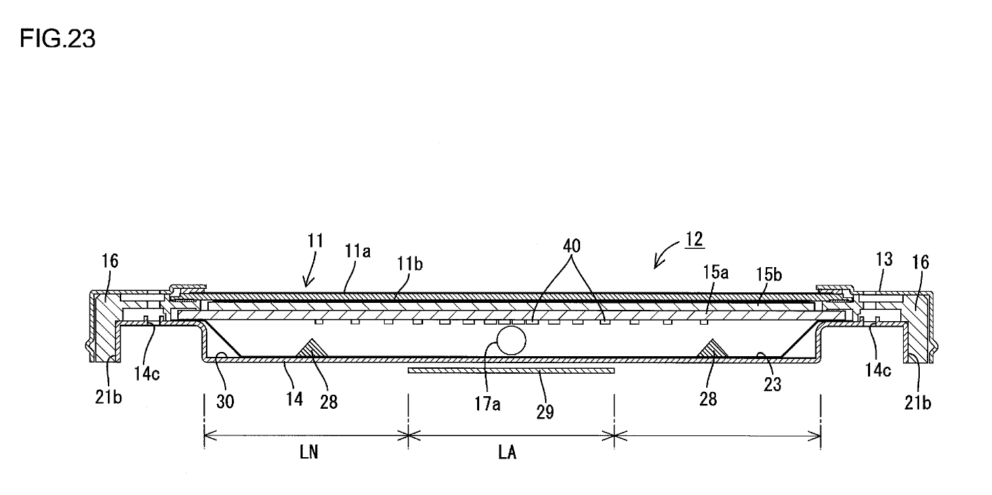

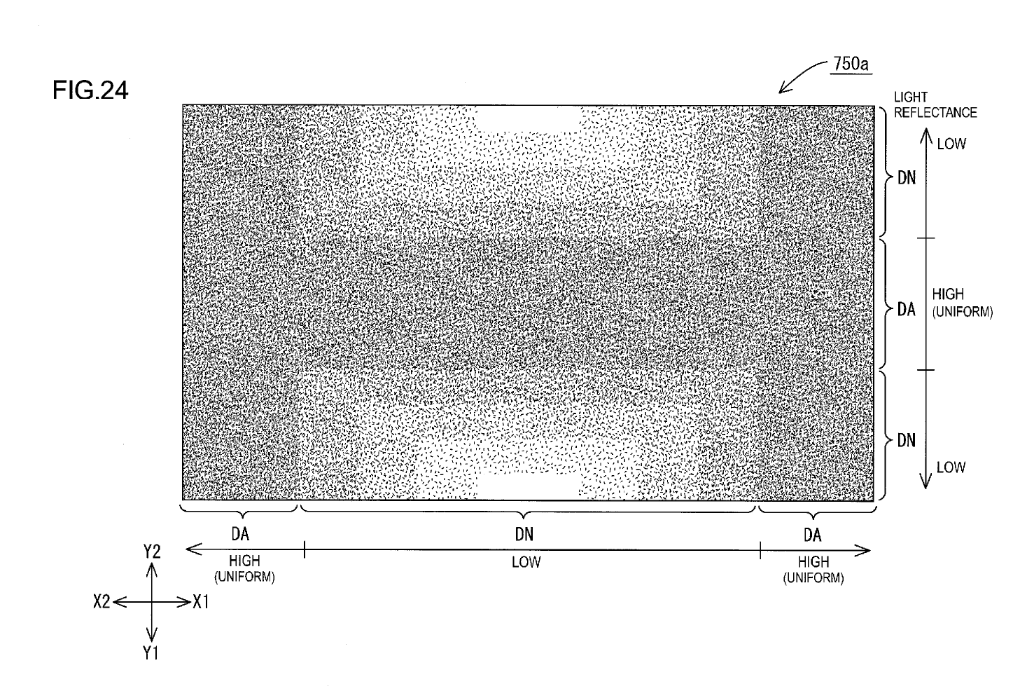

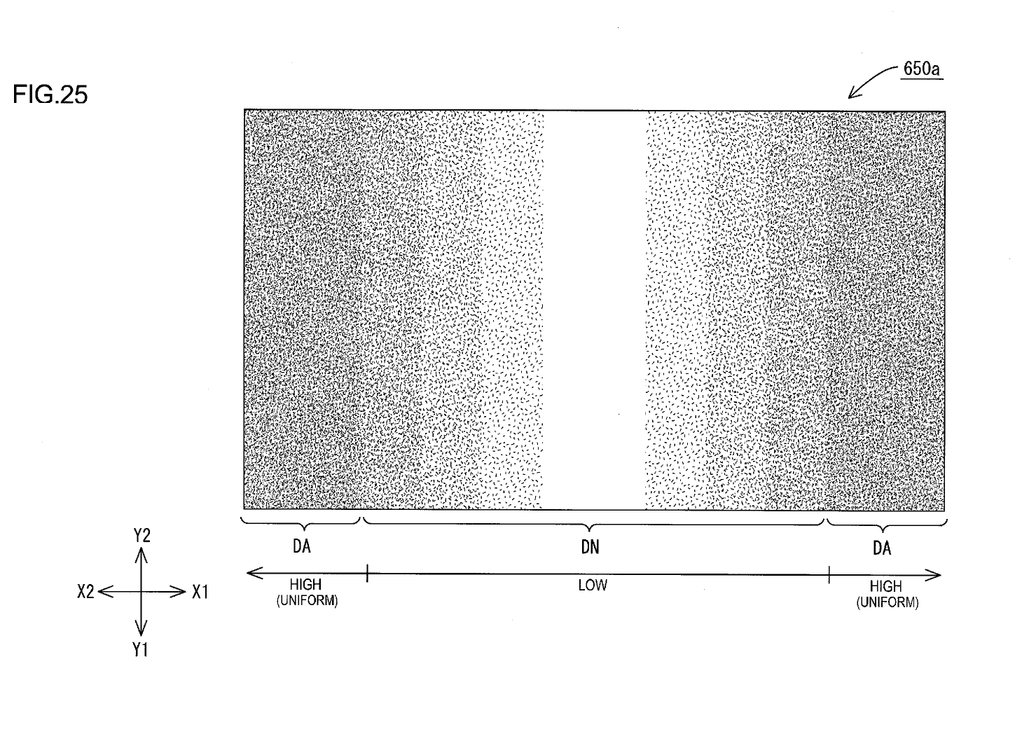

### BRIEF DESCRIPTION OF THE DRAWINGS

[FIG. 1] is an exploded perspective view illustrating a construction of a television receiver according to a first embodiment of the present invention;

[FIG. 2] is an exploded perspective view illustrating a general construction of a liquid crystal display device provided in the television receiver;

[FIG. 3] is a cross-sectional view of the liquid crystal display device along the short-side direction;

[FIG. 4] is a cross-sectional view of the liquid crystal display device along the long-side direction;

[FIG. 5] is a plan view illustrating a general construction of a chassis provided in the liquid crystal display device;

[FIG. 6] is a plan view illustrating an enlarged general construction of a surface of a diffuser plate included in the liquid crystal display device facing cold cathode tubes;

[FIG. 7] is a plan view explaining light reflectance of a surface of the diffuser plate facing the cold cathode tubes;

[FIG. 8] is a graph illustrating a reflectivity change in the short-side direction of the diffuser plate in FIG. 7;

[FIG. 9] is a plan view illustrating light reflectance of a surface of the diffuser plate facing the cold cathode tubes according to one modification;

[FIG. 10] is a graph illustrating a reflectivity change in the short-side direction of the diffuser plate in FIG. 9;

[FIG. 11] is a plan view illustrating light reflectance of a surface of the diffuser plate facing the cold cathode tubes according to another modification;

[FIG. 12] is a graph illustrating a reflectivity change in the short-side direction of the diffuser plate in FIG. 11;

[FIG. 13] is a plan view illustrating light reflectance of a surface of the diffuser plate facing the cold cathode tubes according to another different modification;

[FIG. 14] is a graph illustrating a reflectivity change in the short-side direction of the diffuser plate in FIG. 13;

[FIG. 15] is a plan view illustrating a general construction of a chassis included in the backlight device according to a second embodiment of the present invention;

[FIG. 16] is a plan view illustrating light reflectance of a surface of the diffuser plate included in the backlight device facing the cold cathode tubes;

[FIG. 17] is a graph illustrating a light reflectance change in the short-side direction of the diffuser plate in FIG. 16;

[FIG. 18] is a plan view illustrating a general construction of a chassis included in the backlight device according to a third embodiment of the present invention;

[FIG. 19] is a plan view illustrating light reflectance of a surface of the diffuser plate included in the backlight device facing the cold cathode tubes;

[FIG. 20] is a graph illustrating a reflectivity change in the short-side direction of the diffuser plate in FIG. 19;

[FIG. 21] is a perspective view illustrating one modification of a construction of the optical member;

[FIG. 22] is an enlarged plan view illustrating one modification of a construction of alight reflectance control portion provided on the optical member;

[FIG. 23] is a cross-sectional view illustrating a cross-sectional configuration along the short-side direction of a liquid crystal display device according to a fifth embodiment;

[FIG. 24] is a plan view explaining light reflectance of a surface of a diffuser plate facing cold cathode tubes in a liquid crystal display device according to a sixth embodiment; and

[FIG. 25] is a view explaining a configuration of FIG. 24.

### BEST MODE FOR CARRYING OUT THE INVENTION

### First Embodiment

The first embodiment of the present invention will be explained with reference to FIGS. 1 to 8.

First, a construction of a television receiver TV including a liquid crystal display device 10 will be explained.

FIG. 1 is an exploded perspective view illustrating a general construction of the television receiver of this embodiment. FIG. 2 is an exploded perspective view illustrating a general construction of the liquid crystal display device included in the television receiver in FIG. 1. FIG. 3 is a cross-sectional view of the liquid crystal display device in FIG. 2 along the short-side direction. FIG. 4 is a cross-sectional view of the liquid crystal display device in FIG. 2 along the long-side direction. FIG. 5 is a plan view illustrating a general construction of a chassis included in the liquid crystal display device in FIG. 2. In FIG. 5, the long-side direction of the chassis is referred to as an X-axis direction and the short-side direction of the chassis is referred to as a Y-axis direction.

As illustrated in FIG. 1, the television receiver TV of the present embodiment includes the liquid crystal display device 10, front and rear cabinets CA, CB that house the liquid crystal display device 10 therebetween, a power source P, a tuner T and a stand S. An overall shape of the liquid crystal display device (display device) 10 is a landscape rectangular. The liquid crystal display device 10 is housed in a vertical position such that a short-side direction thereof matches a vertical line. As illustrated in FIG. 2, it includes a liquid crystal panel 11 as a display panel, and a backlight device 12 (lighting device), which is an external light source. They are integrally held by a bezel 13 and the like.

Next, the liquid crystal panel 11 and the backlight device 12 included in the liquid crystal display device 10 will be explained (see FIGS. 2 to 4).

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, counter electrodes, color filter having color sections such as R (red), G (green) and B (blue) color sections arranged in a predetermined pattern, and an alignment film are provided. Polarizing plates 11a, 11b are attached to outer surfaces of the substrates (see FIGS. 3 and 4).

As illustrated in FIG. 2, the backlight device 12 includes a chassis 14, an optical sheet set 15 (diffuser plate (optical member, optical diffuser) 15a and a plurality of optical sheets 15b that are disposed between the diffuser plate 15a and the liquid crystal panel 11), and frames 16. The chassis 14 has a substantially box-shape and an opening 14b on the light output side (on the liquid crystal panel 11 side). The frames 16 arranged along the long sides of the chassis 14 holds the long-side edges of the diffuser plate 15a to the chassis 14. The long-side edges of the diffuser plate 15a are sandwiched between the chassis 14 and the frames 16. Cold cathode tubes (light sources) 17, lamp clips 18, relay connectors 19 and lamp holders 20 are installed in the chassis 14. The lamp clips 18 are provided for mounting the cold cathode tube 17 to the chassis 14. The relay connectors 19 are connected to ends of the cold cathode tubes 17 for making electrical connection. The lamp holders 20 collectively cover ends of the cold cathode tubes 17 and the relay connectors 19. A light output side of the backlight device 12 is a side closer to the diffuser plate 15a than the cold cathode tubes 17.

The chassis 14 is prepared by processing a metal plate. It is formed in a substantially shallow box shape. It includes a rectangular bottom plate 30 and outer rims 21, each of which extends upright from the corresponding side of the bottom plate 30 and has a substantially U shape. The outer rims 21 include short-side outer rims 21a and long-side outer rims 21b provided at the short sides and the long sides of the chassis 14, respectively. The bottom plate 30 has a plurality of mounting holes 22 along the long-side edges thereof. The relay connectors 19 are mounted in the mounting holes 22. As illustrated in FIG. 3, fixing holes 14c are provided on the upper surface of the chassis 14 along the long-side outer rims 21b to bind the bezel 13, the frames 16 and the chassis 14 together with screws and the like.

A light reflecting sheet 23 is disposed on an inner surface of the bottom plate 30 of the chassis 14 (on a side that faces the cold cathode tubes 17). The light reflecting sheet 23 is a synthetic resin sheet having a surface in white color that provides high light reflectivity. It is placed so as to cover almost entire inner surface of the bottom plate 30 of the chassis 14. As illustrated in FIG. 4, long-side edges of the light reflecting sheet 23 are lifted so as to cover the long-side outer rims 21b of the chassis 14 and sandwiched between the chassis 14 and the diffuser plate 15a. With this light reflecting sheet 23, light emitted from the cold cathode tubes 17 is reflected to the diffuser plate 15a.

Each cold cathode tube 17 has an elongated tubular shape. A plurality of the cold cathode tubes 17 are installed in the chassis 14 such that they are arranged parallel to each other with the long-side direction thereof aligned along the long-side direction of the chassis 14. Specifically, as illustrated in FIG. 5, the bottom plate 30 of the chassis 14 (a portion facing the diffuser plate 15a) is horizontally and equally divided into a first end portion 30A, a second end portion 30B and a middle portion 30C. The second end portion 30B is located at an end away from the first end portion. The middle portion 30C is located between the first and second end portions 30A, 30B. The cold cathode tubes 17 are arranged in the middle portion 30C of the bottom plate 30 and a light source installation area LA is formed here. No cold cathode tube 17 is arranged in the first end portion 30A and the second end portion 30B of the bottom plate 30, and empty areas LN are formed there. Namely, the cold cathode tubes 17 are arranged only in the middle portion, which is located around the middle of the bottom plate 30 of the chassis 14 in the short-side direction to form the light source installation area LA. The light source installation area LA is smaller than (a half of) each empty area LN. In the present embodiment, each of the first end portion 30A, the second end portion 30B and the middle portion 30C has an equal area (is equally defined). However, a ratio between the portions can be changed and accordingly, the area of the light source installation area LA and the area of the empty areas LN (an area ratio between the areas LA and LN) also can be changed.

In the light source installation area LA of the bottom plate 30 of the chassis 14, the cold cathode tubes 17 are held by the lamp clips 18 (not shown in FIGS. 3 and 4) so as to be supported with a small gap between the cold cathode tubes 17 and the bottom plate 30 of the chassis 14 (reflecting sheet 23) (see FIG. 4). Heat transfer members 27 are disposed in the gap so as to be in contact with a part of the cold cathode tube 17 and the bottom plate 30 (reflecting sheet 23).

Each heat transfer member 27 has a form of a rectangular plate and as illustrated in FIG. 5, each heat transfer member 27 is disposed just under each cold cathode tube 17 such that its longitudinal direction matches an axial direction of the cold cathode tubes 17. When the cold cathode tubes 17 are lit, at the portions where the heat transfer members 27 are disposed, heat can be transferred from the cold cathode tubes 17 having high temperature to the bottom plate 30 of the chassis 14 via the heat transfer members 27. Therefore, the temperature is lowered at the portions of the cold cathode tubes 17 that are in contact with the heat transfer members 27, and the coldest point is forcibly generated at the portions of the cold cathode tubes where the heat transfer members 27 are disposed.

The heat transfer members 27 are arranged in staggered layout on the bottom plate 30 of the chassis 14. That is, one heat transfer member 27 and its adjacent heat transfer members 27, 27 are offset from each other in an alignment direction (the short-side direction of the bottom plate 30) of the cold cathode tubes 17. Namely, the one and the adjacent heat transfer members are not aligned along a line.

In each of the empty areas LN of the bottom plate 30 of the chassis 14, that is, in each of the first end portion 30A and the second end portion 30B of the bottom plate 30, a convex reflecting portion (reflecting portion) 28 extends along the long-side direction of the bottom plate 30 (see FIG. 5). The convex reflecting portion 28 is made of a synthetic resin and has a surface in white color that provides high light reflectivity. Each convex reflecting portion 28 has two sloped surfaces (directing surfaces) 28a, 28a that face the cold cathode tubes 17 and are sloped toward the bottom plate 30. The convex reflecting portion 28 is provided such that its longitudinal direction matches an axial direction of the cold cathode tubes 17 arranged in the light source installation area LA. One sloped surface 28a of the convex reflecting portion 28 directs light emitted from the cold cathode tubes 17 to the diffuser plate 15a.

On the outer surface of the bottom plate 30 of the chassis 14 (on a side opposite from the cold cathode tubes 17), as illustrated in FIGS. 3 and 4, the inverter board set (light source driving board) 29 is provided so as to overlap with the light source installation area LA, more specifically, so as to overlap with ends of the cold cathode tubes 17. Accordingly, drive power is supplied from the inverter board set 29 to the cold cathode tubes 17. Each end of each cold cathode tube 17 has a terminal (not shown) for receiving drive power and electrical connection between the terminal and a harness 29a (see FIG. 4) derived from the inverter board set 29 enables supply of high-voltage drive power. Such electrical connection is established in a relay connector 19 in which the end of the cold cathode tube 17 is fitted. The holders 20 are mounted so as to cover the relay connectors 19.

The holders 20 that cover the ends of the cold cathode tubes 17 and the relay connectors 19 are made of white synthetic resin. Each of them has an elongated substantially box shape that extends along the short side of the chassis 14 as illustrated in FIG. 2. As illustrated in FIG. 4, each holder 20 has steps on the front side such that the diffuser plate 15a and the liquid crystal panel 11 are held at different levels. A part of the holder 20 is placed on top of a part of the corresponding short-side outer rim 21a of the chassis 14 and forms a side wall of the backlight device 12 together with the short-side outer rim 21a. An insertion pin 24 projects from a surface of the holder 20 that faces the outer rim 21a of the chassis 14. The holder 20 is mounted to the chassis 14 by inserting the insertion pin 24 into the insertion hole 25 provided in the top surface of the short-side outer rim 21a of the chassis 14.

The steps of the holder 20 that covers the ends of the cold cathode tubes 17 include three surfaces parallel to the bottom plate 30 of the chassis 14. The short edge of the diffuser plate 15a is placed on the first surface 20a located at the lowest level. A sloped cover 26 extends from the first surface 20a toward the bottom plate 30 of the chassis 14. A short edge of the liquid crystal panel 11 is placed on the second surface 20b of the steps of the holder 20. The third surface 20c located at the highest level is provided such that it overlaps the outer rim 21a of the chassis 14 and comes in contact with the bezel 13.

On the opening 14b side of the chassis 14, the diffuser plate (optical member, light diffuser) 15a and the optical sheet set 15 including the optical sheets 15b are provided. The diffuser plate 15a includes a synthetic resin plate containing scattered light diffusing particles. It diffuses linear light emitted from the cold cathode tubes 17 and has a light reflecting function for reflecting light emitted from the cold cathode tubes 17. The short-side edges of the diffuser plate 15a are placed on the first surface 20a of the holder 20 as described above, and does not receive a vertical force. As illustrated in FIG. 4, the long-side edges of the diffuser plate 15a are sandwiched between the chassis 14 (more precisely the reflecting sheet 23) and the frame 16 and fixed. Accordingly, the diffuser plate 15a covers the opening 14a of the chassis 14.

The optical sheets 15b provided on the diffuser plate 15a includes a diffuser sheet, a lens sheet and a reflecting type polarizing plate layered in this order from the diffuser plate 15a side. Light emitted from the cold cathode tubes 17 passes through the diffuser plate 15a and enters the optical sheets 15b. The optical sheets 15b are provided for converting the light to planar light. The liquid crystal display panel 11 is disposed on the top surface of the top layer of the optical sheets 15b. The optical sheets 15b are held between the diffuser plate 15a and the liquid crystal panel 11.

In this embodiment, sizes of the cold cathode tubes 17 and their arrangements are defined as follows. The diameter of each cold cathode tube 17 used in this embodiment is 4.0 mm. The distance between the cold cathode tubes 17 and the light reflecting sheet 23 is 0.8 mm. The distance between the adjacent cold cathode tubes 17 is 16.4 mm. The distance between the cold cathode tubes 17 and the diffuser plate 15a is 2.7 mm. In this backlight device 12, distances between the components are defined so as to reduce the thickness of the backlight device 12. Especially, the distance between the cold cathode tubes 17 and the diffuser plate 15a and the distance between the cold cathode tubes 17 and the reflecting sheet 23 are reduced. Because of the thickness reduction of the lighting device 12, the liquid crystal display device 10 and that of the television receiver TV are provided with the following thicknesses. The thickness of the liquid crystal display device 10 (i.e., the thickness between the front surface of the liquid crystal panel 11 and the back surface of the backlight device 12) is 16 mm. The thickness of the television receiver TV (i.e., and the thickness between the front surface of the front cabinet Ca and the back surface of the rear cabinet Cb) is 34 mm. Namely, a thin television receiver is provided.

The light reflecting function of the diffuser plate 15a will be explained with reference to FIGS. 6 to 8.

FIG. 6 is a plan view illustrating an enlarged main portion of a surface of the diffuser plate facing the cold cathode tubes. FIG. 7 is a plan view explaining light reflectance of a surface of the diffuser plate in FIG. 6 facing the cold cathode tubes. FIG. 8 is a graph illustrating a light reflectance change in the short-side direction of the diffuser plate in FIG. 6. In FIGS. 6 to 8, the long-side direction of the diffuser plate is referred to as an X-axis direction and the short-side direction thereof is referred to as a Y-axis direction. In FIG. 8, a horizontal axis shows the Y-axis direction (short-side direction) and the light reflectance obtained from the end of the Y-axis direction closer to Y1 (Y1 end) to the center and from the center to the end closer to Y2 (Y2 end) is plotted on a graph.

As illustrated in FIG. 6, the light reflectance control portions 40 that form a white dot pattern are provided on a surface of the diffuser plate 15a facing the cold cathode tubes 17. The dot pattern of the light reflectance control portions 40 are formed by printing paste containing metal oxide, for example, on the surface of the diffuser plate 15a. Preferable printing means is screen printing, inkjet printing and the like.

The surface of the light reflectance control portion 40 facing the cold cathode tube 17 has a light reflectance of 75% and the surface of the diffuser plate 15a facing the cold cathode tube 17 has a light reflectance of 30%. Thus, the light reflectance control portion 40 has a high light reflectance. In the present embodiment, the light reflectance of each material is represented by an average light reflectance measured with a LAV of CM-3700d (measurement area diameter of 25.4 mm) manufactured by Konica Minolta inside the measurement circle. The light reflectance of the light reflectance control portion 40 is measured in the following method. The light reflectance control portion 40 is formed over an entire surface of a glass substrate and the light reflectance of the surface is measured according to the above measurement means.

The diffuser plate 15a has a long-side direction (X-axis direction) and a short-side direction (Y-axis direction). The light reflectance of the surface of the diffuser plate 15a facing the cold cathode tubes 17 changes along the short-side direction by changing the dot pattern of the light reflectance control portion 40 as illustrated in FIGS. 7 and 8. In other words, on the surface of the diffuser plate 15a facing the cold cathode tubes 17, the light reflectance of the portion that overlaps the light source installation area LA (referred to as a light source overlapped portion DA) is higher than the light reflectance of the portion that overlaps the empty area LN (referred to as an empty area overlapping surface DN). More specifically, in the light source overlapped portion DA of the diffuser plate 15a, the light reflectance is uniform to be 50% and represents a maximum value on the diffuser plate 15a. On the other hand, in the empty area overlapping surface DN of the diffuser plate 15a, the light reflectance decreases in a gradual manner from the portion closer to the light source overlapped portion DA toward the portion away from the light source overlapped portion DA. The light reflectance is set to a lowest value that is 30% at two end portions (Y1 end and Y2 end in FIG. 8) of the empty area overlapping surface DN in the short-side direction (Y-axis direction).

A distribution of light reflectance of the diffuser plate 15a is determined by an area of each dot of the light reflectance control portions 40. The light reflectance of the light reflectance control portion 40 is higher than the light reflectance of the diffuser plate 15a. Therefore, the light reflectance relatively increases by relatively increasing the area occupied by the dots of the light reflectance control portions 40 and the light reflectance relatively reduces by relatively reducing the area occupied by the dots of the light reflectance control portions 40. Specifically, in the light source overlapped area DA of the diffuser plate 15a, the area occupied by the dots of the light reflectance control portions 40 is relatively large and uniform. The area occupied by the dots of the light reflectance control portions 40 is continuously reduced from a border between the light source overlapped portion DA and the empty area overlapping surface DN toward the two end portions of the non-light overlapped portions DN in the short-side direction. As control means for controlling the light reflectance, the area of each dot of the light reflectance control portions 40 may be set to be same and a distance between the dots may be changed.

As is explained above, according to the present embodiment, the chassis 14 included in the backlight device 12 is configured such that the bottom plate 30 facing the diffuser plate 15a is defined in the first end portion 30A, the second end portion 30B and the middle portion 30C sandwiched between the first and second end portions 30A, 30B. The middle portion 30C corresponds to the light source installation area LA where the cold cathode tubes 17 are arranged and the first end portion 30A and the second end portion 30B correspond to the empty areas LN where no cold cathode tube 17 is arranged. Thus, compared to a case in which the cold cathode tubes are installed evenly in the entire chassis, the number of cold cathode tubes 17 is reduced and a cost reduction and power saving of the backlight device 12 are achieved.

On the surface of the diffuser plate 15a facing the cold cathode tubes 17, the light reflectance of the portion (light source overlapped portion) DA that overlaps the light source installation area LA is higher than the light reflectance of the portion (empty area overlapping surface) DN that overlaps the empty area LN. This suppresses brightness nonuniformity of illumination light from the backlight device 12.

As described above, if the empty area LN where no cold cathode tube 17 is arranged is provided, light is not output from the empty area LN. Therefore, the illumination light output from the backlight device 12 is dark at the portion corresponding to the empty area LN and this may cause uneven light distribution. However, according to the configuration of the present invention, light output from the light source installation area LA first reaches the light source overlapped portion DA of the diffuser plate 15a that is the portion having the relatively high light reflectance. Therefore, most of the light reflects off the light source overlapped portion DA (does not pass through the light source overlapped portion DA), and the brightness of illumination light is suppressed with respect to the light emission amount from the cold cathode tubes 17. On the other hand, the light that reflects off the light source overlapped portion DA further reflects off the reflecting sheet 23 and the like in the chassis 14 and reaches the empty area overlapping surface DN of the diffuser plate 15a. The light reflectance of the empty area overlapping surface DN is relatively low and a larger amount of light passes through the empty area overlapping surface DN and thus predetermined brightness of illumination light is achieved. As a result, the backlight device 12 can provide uniform illumination light brightness.

Thus, the light emitted from the cold cathode tubes 17 in the light source installation area LA is reflected in the chassis 14 by the portion (light source overlapped portion DA) of the diffuser plate 15a having relatively high light reflectance so as to be introduced to the empty area LN. Also, the light reflectance of the empty area overlapping surface DN corresponding to the empty area LN is relatively low. Therefore, the illumination light can be output from the empty area LN where no cold cathode tube 17 is arranged. As a result, the cold cathode tubes 17 are not necessary to be installed in the entire chassis 14 to maintain the illumination light uniformity of the backlight device 12, and a cost reduction and power saving are achieved.

The configuration of the present invention is effective especially for the thin backlight device 12 of the present embodiment to suppress the brightness nonuniformity. In the thin backlight device 12, a distance between the cold cathode tubes 17 and the diffuser plate 15a is small and a lamp image may be visible. To suppress the generation of the lamp image, the cold cathode tubes have been tightly installed (that is, a plurality of cold cathode tubes have been installed), and this increases a cost. However, according to the configuration of the present invention, it is needless to say that no lamp image is occurred in the empty area LN. Further, in the light source installation area LA, a relatively large amount of the linear light emitted from the cold cathode tubes 17 is reflected by the portion of the diffuser plate 15a having relatively high light reflectance (light source overlapped portion DA). Therefore, the linear light is less likely to pass through the diffuser plate 15a and a lamp image is less likely to be generated. As a result, in the thin backlight device 12, without increasing the number of cold cathode tubes 17 or with the decreased number of the cold cathode tubes 17, generation of lamp images is suppressed and a cost reduction and illumination having uniform brightness are achieved.

In the present embodiment, the light reflectance of the surface of the diffuser plate 15a facing the cold cathode tubes 17 is uniform within the portion that overlaps the light source installation area LA (light source overlapped portion DA).

According to such a configuration, the light emitted from the cold cathode tubes 17 in the light source installation area LA evenly reflects off (or passes through) the diffuser plate 15a, and therefore, uniform illumination light can be easily obtained in the light source installation area LA.

In the present embodiment, on the bottom plate 30 of the chassis 14, the light source installation area LA is smaller than the empty areas LN.

Even if the light source installation area LA is relatively small, the light reflectance changes by the portions of the diffuser plate 15a like the configuration of the present embodiment, and therefore the light emitted from the cold cathode tubes 17 can be directed toward the empty areas LN inside the chassis 14. This maintains uniformity of illumination brightness and greater effects can be expected in lowering a cost and saving power.

In the present embodiment, the light source installation area LA is provided in the middle portion 30C of the bottom plate 30 of the chassis 14.

According to such a configuration, sufficient brightness is ensured at the middle portion of the backlight device 12 and the brightness at the middle portion of a display is ensured in the television receiver TV including the backlight device 12, and therefore good visibility can be obtained.

In the present embodiment, in the portion of the diffuser plate 15a that overlaps the empty area LN, the light reflectance of a surface of the portion facing the cold cathode tubes 17 (empty area overlapping surface DN) is higher in a portion closer to the portion of the diffuser plate 15a that overlaps the light source installation area LA (light source overlapped portion DA) than a portion farther from the light source overlapped portion DA.

According to such a configuration, the light that reaches the empty area overlapping surface DN of the diffuser plate 15a is relatively easily reflected in the portion closer to the light source overlapped portion DA and the reflected light reaches the portion farther from the light source overlapped portion DA. In the portion away from the light source overlapped portion DA, the light reflectance is relatively low. Therefore, a larger amount of light passes therethrough and predetermined brightness of illumination light can be obtained. Therefore, the brightness of illumination light is set to substantially uniform in the empty area overlapping surface DN (empty area LN) and a moderate distribution of illumination brightness can be achieved in the backlight device 12.

Especially in the present embodiment, the light reflectance in the empty area overlapping surface DN of the diffuser plate 15a decreases in a gradual manner from the portion closer to the light source overlapped portion DA to the portion away from the light source overlapped portion DA.

The light reflectance in the empty area overlapping surface DN decreases in a gradual manner from the portion closer to the light source overlapped portion DA to the portion away therefrom so as to have a gradation. This makes the distribution of illumination light brightness in the empty area overlapping surface DN (empty area LN) to be further moderate and the backlight device 12 can achieve a further moderate distribution of illumination light brightness.

In the present embodiment, the light reflectance control portions 40 having the light reflectance higher than the diffuser plate 15a are formed on the surface of the diffuser plate 16a facing the cold cathode tubes 17.

According to such a configuration, a relatively large number of light reflectance control portions 40 are formed (the area occupied by the dots is increased) in the portion of the diffuser plate 15a where the light reflectance is required to be increased, and a relatively small number of light reflectance control portions 40 are formed (the area occupied by the dots is reduced) in the portion of the diffuser plate 15a where the light reflectance is required to be reduced. Accordingly, the light reflectance of the surface of the diffuser plate 15a can be easily changed. Further, the cold cathode tubes 17 that emit linear light are used in the present embodiment, and therefore, linear light passing through the light reflectance control portions 40 enters the diffuser plate 15a, diffused and converted into planer light. This makes the distribution of illumination brightness of the backlight device 12 to be moderate.

In the present embodiment, the convex reflecting portions 28 having the sloped surfaces 28a that reflect (direct) the light emitted from the cold cathode tubes 17 to the diffuser plate 15a are provided in the empty areas LN of the bottom plate 30 of the chassis 14.

According to such a configuration, the light emitted from the cold cathode tubes 17 that are arranged in the light source installation area LA can be reflected to the diffuser plate 15a by the sloped surfaces 28a of the convex reflecting portions 28. Therefore, the emission light is effectively used and it is further reliably suppressed that the empty areas LN are darkened.

In the present embodiment, the inverter board set 29 that supplies drive power to the cold cathode tubes 17 is arranged in the portion of the chassis 14 that overlaps the light source installation area LA.

This reduces a distance between the cold cathode tubes 17 and the inverter board set 29 to the smallest possible distance. This shortens the length of the harness 29a for supplying drive power of high voltage from the inverter board set 29 and this ensures reliable safety. Further, the size of the inverter board set 29 is enabled to be minimum. This lowers a cost compared to the case in that the inverter board set is formed over the entire chassis 14. Also, surrounding components can be arranged in a space generated due to size reduction of the inverter board set 29 and this makes the backlight device 12 thinner.

In the present embodiment, the heat transfer members 27 are disposed between the cold cathode tubes 17 and the bottom plate 30 of the chassis 14 for transferring heat therebetween.

According to such a configuration, heat is transferred from the cold cathode tubes 17 that are lit and have high temperature to the chassis 14 via the heat transfer members 27. Therefore, the temperature of the cold cathode tubes is lowered at the portions in which the heat transfer members 27 are arranged and the coldest points are forcibly generated there. As a result, the brightness of each one of the cold cathode tubes 17 is improved and this contributes to power saving. Especially according to the configuration of the present invention, the cold cathode tubes 17 are arranged only in the light source installation area LA. Therefore, compared to the case in that the cold cathode tubes 17 are installed evenly in the entire chassis 14, the distance between the cold cathode tubes 17 can be reduced and the cold cathode tubes 17 are installed to overlap with the portions of the diffuser plate 15a having high light reflectance. Therefore, even if the coldest points are generated in the cold cathode tubes 17, it can be designed such that the brightness nonuniformity of the cold cathode tubes 17 is less likely to be recognized.

Especially in the present embodiment, a plurality of heat transfer members 27 are arranged and one heat transfer member and its adjacent two heat transfer members are offset from each other in the alignment direction of the cold cathode. Therefore, the heat transfer members 27 are not arranged on the straight line and the nonuniformity brightness is less likely to be recognized.

### First Modification

A first modification of the backlight device 12 according to the present embodiment will be explained with reference t o FIGS. 9 and 10. In this modification, the distribution of light reflectance of the diffuser plate is changed.

FIG. 9 is a plan view illustrating light reflectance of a surface of the diffuser plate facing the cold cathode tubes according to one modification. FIG. 10 is a graph illustrating a reflectivity change in the short-side direction of the diffuser plate in FIG. 9.

As illustrated in FIGS. 9 and 10, the light source overlapped portion DA of a diffuser plate 150a (a surface of the portion that overlaps the light source installation area LA facing the cold cathode tubes 17) has the highest light reflectance, and in the empty area overlapping surface DN of the diffuser plate 150a (a surface of the portion that overlaps the empty area LN facing the cold cathode tubes 17), the light reflectance decreases in a stepwise manner from the portion closer to the light source overlapped portion DA toward the portion farther therefrom. Namely, in the empty area overlapping surface DN of the diffuser plate 150a, the light reflectance changes step by step along the short-side direction (Y-axis direction) of the diffuser plate 150a. More specifically, as illustrated in FIG. 9, a first area 51 having relatively high light reflectance is provided in the light source overlapped portion DA that is located in the center of the diffuser plate 150a, and second areas 52, 52 having light reflectance relatively lower than the first area 51 are provided next to the first area 51 in the empty area overlapping surface DN located at the sides of the first area 51. Further, in the empty area overlapping surface DN, third areas 53, 53 having light reflectance relatively lower than the second areas 52 are provided at the sides of the second areas 52, fourth areas 54, 54 having light reflectance lower than the third areas 53 are provided at the sides of the third areas 53, and fifth areas 55, 55 having light reflectance lower than the fourth areas 54 are provided at the sides of the fourth areas 54.

In this modification, as illustrated in FIG. 10, the light reflectance of the diffuser plate 150a is 50% in the first area, 45% in the second area, 40% in the third area, 35% in the fourth area, and 30% in the fifth area and it changes with equal ratio. In the first to fourth areas, the area occupied by the dots of the light reflectance control portions 40 is changed to determine the above light reflectance, and the light reflectance in the fifth area in which no light reflectance control portion 40 is provided is represented by the light reflectance of the diffuser plate 150a.

A plurality of areas 52, 53, 54, 55 having different light reflectance are defined in the empty area overlapping surface DN of the diffuser plate 150a. The light reflectance is reduced from the second area 52 to the fifth area 55 sequentially in this order such that the light reflectance decreases in a stepwise manner from the portion closer to the light source overlapped portion DA toward the portion farther therefrom.

According to such a configuration, the brightness distribution of illumination light in the empty area overlapping surface DN (empty area LN) is made moderate and the backlight device 12 can obtain a moderate illumination brightness distribution. With the means for forming a plurality of areas 52, 53, 54, 55 having different light reflectance, a manufacturing method of the diffuser plate 150a becomes simple and this contributes to a cost reduction.

### Second Modification

A second modification of the backlight device 12 according to the present embodiment will be explained with reference to FIGS. 11 and 12. The distribution of light reflectance of the diffuser plate is further modified in this modification.

FIG. 11 is a plan view illustrating light reflectance of a surface of the diffuser plate facing the cold cathode tubes according to another modification. FIG. 12 is a graph illustrating a reflectivity change in the short-side direction of the diffuser plate in FIG. 11.

As illustrated in FIGS. 11 and 12, a diffuser plate 250a is configured such that the light reflectance is lower at the ends than the middle portion in its short-side direction (Y-axis direction). Namely, in the entire diffuser plate 250a, the light reflectance of the light source overlapped portion DA (a surface of the portion that overlaps the light-source installation area LA facing the cold cathode tubes 17) that is located at its middle portion is relatively higher than the light reflectance of the empty area overlapping surface DN (a surface of the portion that overlaps the empty area LN facing the cold cathode tubes 17). Further, also in the light source overlapped portion DA and the empty area overlapping surface DN, the light reflectance becomes reduced from the middle portion toward the ends of the diffuser plate 250a.

In this modification, as illustrated in FIG. 12, the light reflectance of the diffuser plate 250a is 50% at the middle portion and 30% at the Y1 end and the Y2 end, and it continuously changes from 50% to 30% from the middle portion to the ends.

According to such a configuration, the distribution of illumination light brightness in the entire diffuser plate 250a can be moderate and accordingly the backlight device 12 can obtain the moderate distribution of illumination light brightness. Such a configuration is especially preferable for the television receiver TV including the backlight device 12 that has high brightness in the vicinity of the middle portion of the display.

### Third Modification

Next, a third modification of the backlight device 12 according to the present embodiment will be explained with reference to FIGS. 13 and 14. The distribution of light reflectance of the diffuser plate is further modified in this modification.

FIG. 13 is a plan view illustrating light reflectance of a surface of the diffuser plate facing the cold cathode tubes according to another different modification. FIG. 14 is a graph illustrating a reflectivity change in the short-side direction of the diffuser plate in FIG. 13.

In a diffuser plate 350a, as illustrated in FIGS. 13 and 14, the light source overlapped portion DA (a surface of the portion that overlaps the light source installation area LA facing the cold cathode tubes 17) has relatively high light reflectance, and the empty area overlapping surface DN (a surface of the portion that overlaps the empty area LN facing the cold cathode tubes 17) has relatively low light reflectance. Further, the light reflectance is uniform in the light source overlapped portion DA and in the empty area overlapping surfaces DN. In this modification, the light reflectance of the diffuser plate 350a is 50% in the light source overlapped portion DA that is located in the middle portion, and 30% in the empty area overlapping surfaces DN that are located at the ends as illustrated in FIG. 12.

The distribution of the light reflectance of the diffuser plate 350a is obtained by forming the light reflectance control portions 40 as follows. The area occupied by the dots of the light reflectance control portions 40 are relatively increased in the light source overlapped portion DA and the area occupied by the dots is uniform within the light source overlapped portion DA. On the other hand, the area occupied by the dots of the light reflectance control portions 40 is relatively reduced in the empty area overlapping surface DN and the area occupied by the dots is uniform within the empty area overlapping surface DN.

Another example of the light reflectance control portions 40 will be described below. The light reflectance control portions 40 where the area occupied by the dots is uniform are formed in the light source overlapped portion DA. On the other hand, in the empty area overlapping surfaces DN, no light reflectance control portion 40 is formed and a surface of the diffuser plate 350a is exposed in an entire surface of the empty area overlapping surfaces DN. Accordingly, relatively low and uniform light reflectance is obtained in the empty area overlapping surfaces DN.

According to such a configuration, the light reflectance control portions 40 are formed only in the middle portion of the diffuser plate 350a and this simplifies a manufacturing method of the diffuser plate 350a and contributes to a cost reduction.

### Second Embodiment

Next, a second embodiment of the present invention will be explained with reference to FIGS. 15 to 17. In the second embodiment, the arrangement of the cold cathode tubes and the distribution of light reflectance of the diffuser plate are modified, and other configurations are same as the above embodiment. The same parts as the above embodiment are indicated by the same symbols and will not be explained.

FIG. 15 is a plan view illustrating a general construction of a chassis included in the backlight device according to the second embodiment. FIG. 16 is a plan view illustrating light reflectance of a surface of the diffuser plate included in the backlight device facing the cold cathode tubes. FIG. 17 is a graph illustrating a light reflectance change in the short-side direction of the diffuser plate in FIG. 16. In FIGS. 15 to 17, the long-side direction of the chassis and the diffuser plate is referred to as X-axis direction and the short-side direction thereof is referred to as Y-axis direction. In FIG. 17, a horizontal axis represents the Y-axis direction (short-side direction) and the light reflectance is plotted on a graph from the end closer to the Y1 (Y1 end) to the middle portion and from the middle portion to the end closer to the Y2 (Y2 end) in the Y-axis direction.

Each cold cathode tube 17 has an elongated tubular shape. A plurality of cold cathode tubes 17 are arranged in portions of the chassis 14 such that they are arranged parallel to each other with the longitudinal direction (axial direction) thereof aligned along the long-side direction of the chassis 14. More specifically, as illustrated in FIG. 15, a bottom plate 60 of the chassis 14 (a portion facing a diffuser plate 450a) is defined in the short-side direction in a first end portion 60A, a second end portion 60B that is located at an end opposite from the first end portion 60A and a middle portion 60C that is sandwiched between the first end portion 60A and the second end portion 60B. The same number of cold cathode tubes 17 are arranged in the first end portion 60A and the second end portion 60B of the bottom plate 60 respectively and a light source installation area LA-1 is formed in the first end portion 60A and the second end portion 60B. On the other hand, no cold cathode tube 17 is arranged in the middle portion 60C of the bottom plate 60 and a empty area LN-1 is formed in the middle portion 60C. Namely, the cold cathode tubes 17 are arranged in the two end portions of the bottom plate 60 of the chassis in the short-side direction to form the light source installation areas LA-1.

The diffuser plate 450a is provided on the opening side of the chassis 14 (light output side of the cold cathode tubes 17). The diffuser plate 450a has a long-side direction (X-axis direction) and a short-side direction (Y-axis direction), and light reflectance of a surface of the diffuser plate 450a facing the cold cathode tubes 17 changes along the short-side direction as illustrated in FIGS. 16 and 17. Namely, on the surface of the diffuser plate 450a facing the cold cathode tubes 17, the light reflectance of the portion that overlaps the light source installation area LA-1 (referred to as the light source overlapped portion DA-1 hereinafter) is higher than the light reflectance of the portion that overlaps the empty area LN-1 (referred to as the empty area overlapping surface DN-1). More specifically, the light reflectance is 50% and uniform in the light source overlapped portion DA-1 of the diffuser plate 450a and it is a maximum value in the diffuser plate 450a. On the other hand, in the empty area overlapping surface DN-1 of the diffuser plate 450a, the light reflectance decreases in a gradual manner from the portion closer to the light source overlapped portion DA-1 to the portion farther therefrom. The light reflectance is 30% that is a minimum value in the middle portion (center in FIG. 17) of the empty area overlapping surface DN-1 in the short-side direction (Y-axis direction).

As is explained above, according to this embodiment, in the chassis 14 included in the backlight device 12, the bottom plate 60 facing the diffuser plate 450a is defined in the first end portion 60A, the second end portion 60B and the middle portion 60C that is sandwiched between the first and second end portions 60A, 60B. The first end portion 60A and the second end portion 60B correspond to the light source installation areas LA-1 where the cold cathode tubes 17 are arranged, and the middle portion 60C corresponds to the empty area LN-1 where no cold cathode tube 17 is arranged. Accordingly, compared to the case in that the cold cathode tubes are evenly installed in the entire chassis, the number of cold cathode tubes 17 is reduced and a cost reduction and power saving of the backlight device 12 are enabled.

Further, in this embodiment, the light source installation area LA-1 is provided in the first end portion 60A and the second end portion 60B of the bottom plate 60, and the light reflectance of the portion of the diffuser plate 450a that overlaps the light source installation area LN-1 (light source overlapped portion DA-1) is higher than the light reflectance of the portion that overlaps the empty area LN-1 (empty area overlapping surface DN-1).

According to such a configuration, light emitted from the light source installation areas LA-1 that are provided at the ends of the chassis 14 first reaches the light source overlapped portions DA-1 of the diffuser plate 450a that have relatively high light reflectance. Therefore, most of the light is reflected by the light source overlapped portions DA-1 to the empty area LN-1. Therefore, the light enters the empty area LN-1 from the two ends thereof, and light is supplied to this area. Additionally, the light reflectance of the empty area overlapping surface DN-1 facing the non-light installation area LN-1 is relatively low, and therefore a large amount of light passes therethrough. As a result, the empty area LN-1 is reliably prevented from being darkened.

### Third Embodiment

Next, a third embodiment of the present invention will be explained with reference to FIGS. 18 to 20. In the third embodiment, the arrangement of the cold cathode tubes and the distribution of the light reflectance of the diffuser plate are further modified and other configurations are same as the first embodiment. The same parts as the first embodiment are indicated by the same symbols and will not be explained.

FIG. 18 is a plan view illustrating a general construction of a chassis included in the backlight device according to this embodiment. FIG. 19 is a plan view illustrating light reflectance of a surface of the diffuser plate included in the backlight device facing the cold cathode tubes. FIG. 20 is a graph illustrating a reflectivity change in the short-side direction of the diffuser plate in FIG. 19. In FIGS. 18 to 20, the long-side direction of the chassis and the diffuser plate is referred to as X-axis direction and the short-side direction thereof is referred to as Y-axis direction. In FIG. 20, a horizontal axis represents the Y-axis direction (short-side direction) and the light reflectance is plotted on a graph from the end closer to the Y1 (Y1 end) to the middle portion and from the middle portion to the end closer to the Y2 (Y2 end) in the Y-axis direction.

Each cold cathode tube 17 has an elongated tubular shape. A plurality of the cold cathode tubes 17 are arranged in portions of the chassis 14 such that they are arranged parallel to each other with the longitudinal direction (axial direction) thereof aligned along the long-side direction of the chassis 14. More specifically, as illustrated in FIG. 18, a bottom plate 70 of the chassis 14 (a portion facing a diffuser plate 550a) is defined in the short-side direction in a first end portion 70A, a second end portion 70B that is located at an end opposite from the first end portion 70A and a middle portion 70C that is sandwiched between the first end portion 70A and the second end portion 70B. The cold cathode tubes 17 are arranged in the second end portion 70A of the bottom plate 60 and a light source installation area LA-2 is formed in the second end portion 70B. On the other hand, no cold cathode tube 17 is arranged in the first end portion 70A and the middle portion 70C of the bottom plate 60 and an empty area LN-2 is formed there. Namely, the cold cathode tubes 17 are arranged at one end of the bottom plate 60 of the chassis (the end closer to Y1) to form a light source installation area LA-2.

The diffuser plate 550a is provided on the opening side of the chassis 14 (light output side of the cold cathode tubes 17). The diffuser plate 550a has a long-side direction (X-axis direction) and a short-side direction (Y-axis direction), and light reflectance of a surface of the diffuser plate 550a facing the cold cathode tubes 17 changes along the short-side direction as illustrated in FIGS. 19 and 20. Namely, on the surface of the diffuser plate 550a facing the cold cathode tubes 17, the light reflectance of the portion that overlaps the light source installation area LA-2 (referred to as the light source overlapped portion DA-2 hereinafter) is higher than the light reflectance of the portion that overlaps the empty area LN-2 (referred to as the empty area overlapping surface DN-2). More specifically, the light reflectance is 50% and uniform in the light source overlapped portion DA-2 of the diffuser plate 550a (one end of the diffuser plate 550a in the short-side direction, the Y1 end in FIG. 20) and it is a maximum value in the diffuser plate 450a. On the other hand, in the empty area overlapping surface DN-2 of the diffuser plate 550a, the light reflectance decreases in a gradual manner from the portion closer to the light source overlapped portion DA-2 to the portion away therefrom. The light reflectance is 30% that is a minimum value at the other end of the diffuser plate 550a (the Y2 end in FIG. 20) in the short-side direction.

As is explained above, according to this embodiment, in the chassis 14 included in the backlight device 12, the bottom plate 70 facing the diffuser plate 550a is defined in the first end portion 70A, the second end portion 70B and the middle portion 70C that is sandwiched between the first and second end portions 70A, 70B. The second end portion 70B corresponds to the light source installation areas LA-2 where the cold cathode tubes 17 are arranged, and the first end portion 70A and the middle portion 70C correspond to the empty area LN-2 where no cold cathode tube 17 is arranged. Accordingly, compared to the case in that the cold cathode tubes are evenly installed in the entire chassis, the number of cold cathode tubes 17 is reduced and a cost reduction and power saving of the backlight device 12 are enabled.

Further, in this embodiment, the light source installation area LA-2 is provided in the second end portion 70B of the bottom plate 70, and the light reflectance of the portion of the diffuser plate 550a that overlaps the light source installation area LA-2 (light source overlapped portion DA-2) is higher than the light reflectance of the portion that overlaps the empty area LN-2 (empty area overlapping surface DN-2).

According to such a configuration, light emitted from the light source installation area LA-2 first reaches the light source overlapped portion DA-2 of the diffuser plate 550a that has relatively high light reflectance and most of the light is reflected by the light source overlapped portion DA-2. The reflected light is further reflected by the reflecting sheet 23 or the like in the chassis 14 and reaches the empty area overlapping surface DN-2. The light reflectance of the empty area overlapping surface DN-2 is relatively low, and therefore a larger amount of light passes therethrough and predetermined brightness of the illumination light can be obtained. As a result, the backlight device 12 can achieve uniformity of the illumination brightness. This configuration is especially effective for the backlight device 12 where high brightness is required only at one end of the backlight device.

### Fourth Embodiment

Next, a fourth embodiment will be explained with reference to FIG. 21. In the fourth embodiment, the configuration of the optical member including the diffuser plate is modified and other configurations are same as the first embodiment. The same parts as the first embodiment are indicated by the same symbols and will not be explained.

FIG. 20 is a perspective view illustrating a general construction of the optical member included in the backlight device according to the present embodiment.

The optical member 80 that is provided so as to cover the opening of the chassis 14 includes a glass substrate (light reflectance control member) 81 that is provided closer to the cold cathode tubes 17 and a diffuser sheet (optical diffuser) 650a that is provided on a surface of the glass substrate 81 opposite from the cold cathode tubes 17. The diffuser sheet 650a is formed of a thin sheet and diffuses light that enters the diffuser sheet. The light reflectance of a surface of the diffuser sheet 650a facing the glass substrate 81 (a surface closer to the cold cathode tubes 17) is 30%.

The glass substrate 81 is formed of a homogeneous plate member having translucency and has a predetermined thickness not to cause deflection due to its own weight. The light reflectance of the glass substrate 81 is quite low and is 3%. The glass substrate 81 has the light reflectance control portions 40 having a white dot pattern on a surface facing the cold cathode tubes 17. The light reflectance control portions 40 have the light reflectance of 75% that is higher than that of the glass substrate 81 and the diffuser sheet 650a.

As is explained above, according to this embodiment, the optical member 80 included in the backlight device 12 includes the glass substrate 81 provided closer to the cold cathode tubes 17 and the diffuser sheet 650a provided on the glass substrate 81. The light reflectance control portions 40 having light reflectance higher than the glass substrate 81 and the diffuser sheet 650a are formed on the surface of the glass substrate 81 facing the cold cathode tubes 17.

According to such a configuration, the light reflectance of the light reflectance control portions 40 is higher than that of the glass substrate 81 and the diffuser sheet 650a, and therefore, the amount of light entering the optical member 80 from the cold cathode tubes 17 can be controlled by the configuration of the light reflectance control portions 40.

Especially in this embodiment, the thin diffuser sheet 650a is placed on the glass substrate 81 formed of a plate having a predetermined thickness.

The diffuser sheet 650a is expensive compared to the glass substrate 81 and it is desirable to make the diffuser sheet 650a thinner to reduce a cost of the backlight device 12. However, if only the diffuser sheet 650a is provided in the device, deflection occurs in the diffuser sheet 650a due to its own weight and the diffuser sheet 650a may be in contact with the cold cathode tubes 17. The diffuser sheet 650a is placed on the glass substrate 81 that is formed of a plate member. This suppresses deflection from occurring in the optical member 80 and contributes to a cost reduction.

### Fifth Embodiment

A fifth embodiment of the present invention will be explained with reference to FIG. 23.

In the fifth embodiment, a cross-sectional configuration (FIG. 23) along the short-side direction (Y-axis direction) of a liquid crystal display device will be explained and other configurations are same as the first embodiment. The same parts as the first embodiment are indicated by the same symbols and will not be explained.

As illustrated in FIG. 23, the backlight device 12 is configured to include one hot cathode tube 17a in the chassis 14 and only the hot cathode tube 17a functions as a light supply source such that illumination light is supplied to the liquid crystal panel 11. The hot cathode tube 17a has a tubular diameter of approximately 15 mm and has approximately 50 W to 80 W, and current of 400 mArms to 700 mArms flows therethrough.

Like the first embodiment, the light reflectance control portions 40 are formed in a dot pattern on a surface of the diffuser plate 15a closer to the hot cathode tube 17a. The surface portion of the diffuser plate 15a just above the hot cathode tube 17a has high light reflectance and the area occupied by the dots of the light reflectance control portions 40 are continuously reduced toward the two ends of the diffuser plate 15a in the short-side direction (Y-axis direction) of the chassis 14 and/or a distance between the dots of the light reflectance control portions 40 is continuously increased. Accordingly, the light reflectance continuously decreases toward the two ends of the diffuser plate 15a in the short-side direction (Y-axis direction of the chassis 14.

According to the fifth embodiment, since the light source is comprised of only one hot cathode tube 17a, a cost is significantly reduced compared to the case in which a plurality of cold cathode tubes 17 are arranged in parallel to each other, and since the non-light source layout area LN is enlarged, portions in the liquid crystal display device that can be made thinner is enlarged and this increases a variety of design. Further, light emitted from the hot cathode tube 17a can be dispersed substantially evenly on a surface by the light reflectance control portions 40, and therefore, uniformity of brightness can be ensured.

The decrease in the light reflectance is not necessarily continuous toward the ends in the short-side direction (Y-axis direction) of the chassis 14. The light reflectance may decrease in a stepwise manner toward the ends.

### Sixth Embodiment

Next, a sixth embodiment will be explained with reference to FIGS. 24 and 25.

In the sixth embodiment, a distribution of light reflectance of a surface of the diffuser plate facing the cold cathode tubes (FIG. 24) will be explained, and other configurations are same as the first embodiment. The same parts as the first embodiment are indicated by the same symbols and will not be explained. FIG. 25 is a view for supplemental explanation of the contribution in FIG. 24.

In the first embodiment, the dot pattern of the light reflectance control portions 40 is configured to change the light reflectance in the alignment direction (Y-axis direction) of the cold cathode tubes 17 that are linear light sources. In the sixth embodiment, the dot patterns of the light reflectance control portions 40 are configured to change the light reflectance also in the longitudinal direction of the cold cathode tubes 17 (X-axis direction) in addition to the alignment direction of the cold cathode tubes 17 that are linear light sources. Namely, by combining the configuration in which the light reflectance changes in the Y-axis direction as illustrated in FIG. 7 and the configuration in which the light reflectance changes in the X-axis direction, a diffuser sheet 750a having light reflectance change illustrated in FIG. 24 can be provided.

In such a case, the dot pattern of the light reflectance control portions 40 is configured on the diffuser plate 15a so as to satisfy the following distributions of the light reflectance. The light reflectance of the surface of the diffuser plate 15a facing the cold cathode tubes 17 has a change pattern (distribution) same as the first embodiment in the alignment direction of the cod cathode tubes 17 (Y-axis direction). In the longitudinal direction (X-axis direction) of the cold cathode tubes 17, the light reflectance of the diffuser plate 15a closer to the ends (X1, X2) of the cold cathode tubes 17 in their longitudinal direction is higher than the light reflectance of the diffuser plate 15a closer to the center of the cold cathode tubes 17 in their longitudinal direction. As to the change of the light reflectance in the X-axis direction in such a case, the light reflectance may decrease in a gradual manner from the ends to the center of the cold cathode tubes 17 in their longitudinal direction (see FIG. 7) or in a stepwise manner (see FIG. 9).

According to the configuration of the sixth embodiment, in addition to operational effects of the first embodiment, light entering the ends of the diffuser plate 15a in the X-axis direction can be collected to the center and light display can be achieved in the middle portion of the display.

### Other Embodiments

The embodiments of the present invention have been described, however, the present invention is not limited to the above embodiments explained in the above description and the drawings. The following embodiments may be included in the technical scope of the present invention, for example.

(1) In the above embodiments, the light reflectance control portions having a dot pattern are formed on the diffuser plate, however, the configuration of the light reflectance control portions is not limited thereto. For example, as illustrated in FIG. 22, an optical member 750a having light reflectance control portions 90 of a stripe pattern may be used. In such a case, a distance between the stripes or a width of each stripe may be changed to control the light reflectance of a surface of the optical member 750a.

(2) In the above embodiments, the area occupied by the dots of the light reflectance control portions is changed to control the light reflectance, however, the light reflectance control means is not limited thereto. For example, the light reflectance control portions may be formed of a plurality kinds of materials having different light reflectance.

(3) In the above embodiments, the light reflectance control portions are formed on a surface of the diffuser plate to control the light reflectance of the surface of the diffuser plate, however, the light reflectance of the diffuser plate may be controlled as follows. The diffuser plate is generally configured by a translucent substrate containing scattered light diffusing particles. The light reflectance of the diffuser plate can be determined by a combination ratio (weight by %) of the scattered light diffusing particles with respect to the translucent substrate. Namely, the light reflectance can be relatively increased by relatively increasing the combination ratio of the scattered light diffusing particles and the light reflectance can be relatively reduced by relatively reducing the combination ratio of the scattered light diffusing particles.

(4) In the above embodiments, the light source installation area is provided at the center or at the ends of the bottom plate of the chassis. However, for example, the light source installation area may be provided at the center and at one end of the bottom plate. Thus, the present invention includes a configuration in that the position of the light source installation area is changed according to the light amount from the cold cathode tubes or conditions of use for the backlight device.

(5) In the above embodiments, the light reflectance control portions are printed on the surface of the diffuser plate, however, the light reflectance control portions that are formed by other forming means such as metal evaporation are also included in the present invention.

(6) In the above embodiments, the cold cathode tubes or the hot cathode tube are used as the light source, however, other kinds of light source such as LED may be used as the light source.

1. A lighting device comprising:
at least one light source;
a chassis housing the light source and having an opening for light from the light source to pass through; and
an optical member provided so as to face the light source and cover the opening,
wherein:
the chassis has a surface facing the optical member and including at least a first end portion, a second end portion, and a middle portion, the second end portion being located at an end away from the first end portion, and the middle portion being located between the first end portion and the second end portion;
one or two of the first end portion, the second end portion and the middle portion are configured as light source installation areas in each of which the light source is arranged, and the rest is configured as an empty area in which no light source is arranged; and
the optical member has a portion that overlaps the light source installation area at least a surface of which faces the light source has a light reflectance higher than a light reflectance of at least a surface of a portion that overlaps the empty area facing the light source.

2. The lighting device according to claim 1, wherein the light reflectance of at least the surface of the portion that overlaps the light source installation area facing the light source is uniform.

3. The lighting device according to claim 1, wherein the light source installation area of the chassis is smaller than the empty area.

4. The lighting device according to claim 1, wherein the light source installation area is provided in the middle portion of the chassis.

5. The lighting device according to claim 1, wherein the light source installation area is provided in one of the first end portion and the second end portion.

6. The lighting device according to claim 1, wherein the light source installation area is provided in each of the first end portion and the second end portion.

7. The lighting device according to claim 1, wherein the light reflectance of at least the surface of the portion that overlaps the empty area facing the light source is higher on a side close to the portion that overlaps the light source installation area than on a side away therefrom.

8. The lighting device according to claim 1, wherein the light reflectance of at least the surface of the portion that overlaps the empty area facing the light source decreases in a gradual manner from a side close to the portion that overlaps the light source installation area to the side away therefrom.

9. The lighting device according to claim 1, wherein the light reflectance of at least the surface of the portion that overlaps the empty area facing the light source decreases in a stepwise manner from a side close to the portion that overlaps the light source installation area to the side away therefrom.

10. The lighting device according to claim 1, wherein the optical member includes a light diffuser that diffuses light from the light source and a light reflectance control portion on a surface of the light diffuser, the surface facing the light source and having a light reflectance higher than the light diffuser.

11. The lighting device according to claim 1, wherein:
the optical member includes a light reflectance control member on a side close to the light source for reflecting light from the light source, and a light diffuser on an opposite side of the light reflectance control member from the light source for diffusing light from the light source; and
the light reflectance control member includes a light reflectance control portion on a side facing the light source, the light reflectance control portion having a light reflectance higher than the light reflectance control member and the light diffuser.

12. The lighting device according to claim 1, wherein the chassis includes a light reflecting portion having a directing surface for directing light from the light source to the optical member.

13. The lighting device according to claim 1, further comprising a light source driving board configured to supply driving power to the light source, wherein the light source driving board is disposed so as to overlap with the light source installation area.

14. The lighting device according to claim 1, further comprising at least one heat transfer member disposed between the light source and the chassis for transferring heat therebetween.

15. The lighting device according to claim 14, wherein:
the at least one light source including a plurality of light sources is disposed such that the light sources are arranged in parallel to each other; and
the at least one heat transfer member including a plurality of heat transfer members is disposed between the light sources and the chassis such that one heat transfer member and the heat transfer members adjacent to the one heat transfer member are offset from each other in an alignment direction of the light sources.

16. The lighting device according to claim 1, wherein only one light source is disposed inside the chassis.

17. The lighting device according to claim 16, wherein the light source is a hot cathode tube.

18. The lighting device according to claim 1, wherein:
the light source is an elongated linear light source; and
the light reflectance of the surface facing the light source and close to an end of the linear light source is higher than the light reflectance of the surface facing the light source and close to a midpoint of the linear light source.

19. The lighting device according to claim 18, wherein the light reflectance of the surface facing the light source decreases in a gradual manner from an area close to the end of the linear light source to an area close to the midpoint of the linear light source.

20. The lighting device according to claim 18, wherein the light reflectance of the surface facing the light source is decreases in a stepwise manner from an area close to the end of the linear light source to an area close to the midpoint of the linear light source.

21. A display device comprising:
the lighting device according to claim 1; and
a display panel configured to provide display using light from the lighting device for a display device.

22. The display device according to claim 21, wherein the display panel is a liquid crystal display panel using liquid crystal.

23. A television receiver comprising the display device according to claim 21.
